(19) United States
(12) Patent Application Publication
(10) Pub. No.: US 2014/0189564 A1
(43) Pub. Date: Jul. 3, 2014

(54) INFORMATION PROCESSING APPARATUS, INFORMATION PROCESSING METHOD, AND PROGRAM

(71) Applicant: Sony Corporation, Tokyo (JP)

(72) Inventors: MASAYOSHI OHNO, Tokyo (JP); TOSHIHIRO ISHIZAKA, Tokyo (JP)

(73) Assignee: Sony Corporation, Tokyo (JP)

(21) Appl. No.: 14/085,098

(22) Filed: Nov. 20, 2013

(30) Foreign Application Priority Data
Dec. 27, 2012 (JP) 2012-285026

(51) Int. Cl. G06F 3/0484

(52) U.S. Cl. CPC G06F 3/0484
USPC 715/771

(57) ABSTRACT

There is provided an information processing apparatus including a setting change unit configured to change a setting of an apparatus based on operation history information related to an operation history of the apparatus, and a time lapse acquisition unit configured to acquire time lapse information related to a time lapse. The setting change unit combines the time lapse information and the operation history information, and changes the setting of the apparatus.

### CROSS REFERENCE TO RELATED APPLICATION(S)

This application claims the benefit of Japanese Priority Patent Application JP 2012-285026 filed Dec. 27, 2012, the entire contents of which are incorporated herein by reference.

### BACKGROUND

The present disclosure relates to an information processing apparatus, an information processing method, and a program.

Recently, electronic devices such as a digital camera have various functions. Therefore, the operation and setting of the devices are complicated for the user. Moreover, the operation hurdle varies depending on the proficiency level of the operation method. Therefore, a method for switching the operation level of device operation has been suggested (see JP 2008-124885A and JP 2003-44157A listed below).

### SUMMARY

However, there is a case where it is not solved even if the operation level is roughly set. By contrast, in a case where the operation level is set in detail, the setting becomes complicated. In addition, an operation method tends to be forgotten if the operation is not performed for a long time.

Therefore, the present disclosure suggests a method for automatically changing the device setting according to the display and operation state of the device.

According to an embodiment of the present disclosure, there is provided an information processing apparatus including a setting change unit configured to change a setting of an apparatus based on operation history information related to an operation history of the apparatus, and a time lapse acquisition unit configured to acquire time lapse information related to a time lapse. The setting change unit combines the time lapse information and the operation history information, and changes the setting of the apparatus.

According to an embodiment of the present disclosure, there is provided an information processing method including changing a setting of an apparatus based on operation history information related to an operation history of the apparatus, and acquiring time lapse information related to a time lapse. Changing the setting of the apparatus is to combine the time lapse information and the operation history information and change the setting of the apparatus.

According to an embodiment of the present disclosure, there is provided a program that causes a computer to execute changing a setting of an apparatus based on operation history information related to an operation history of the apparatus, and acquiring time lapse information related to a time lapse. Changing the setting of the apparatus is to combine the time lapse information and the operation history information and change the setting of the apparatus.

As described above, according to the present disclosure, it is possible to automatically change the device setting according to the display and operation state of the device.

### BRIEF DESCRIPTION OF THE DRAWINGS

FIG. 1 is a block diagram illustrating a function configuration example of an information processing apparatus 100 according to one embodiment of the present disclosure;

FIG. 2 is a schematic diagram to describe the flow of user registration processing;

FIG. 3 is a schematic diagram to describe the flow of user identification processing;

FIG. 4 is a flowchart to describe one example of user registration processing;

FIG. 5 is a flowchart to describe one example of user identification processing;

FIG. 6 is a diagram to describe help information displayed on a UI display unit 110 of the information processing apparatus 100;

FIG. 7 is a diagram to describe one example of a focus function proficiency level parameter 141;

FIG. 8 is a diagram illustrating a display example of help information of a focus function based on the focus function proficiency level;

FIG. 9 is a diagram to describe one example of the help information group of each of four modes of a focus function;

FIG. 10 is a schematic diagram to describe the flow of decision processing of help information of a focus function;

FIG. 11 is a flowchart to describe one example of decision processing of help information of a focus function;

FIG. 12 is a flowchart to describe one example of A-low/M-low region processing in FIG. 11;

FIG. 13 is a flowchart to describe one example of A-high/M-low region processing in FIG. 11;

FIG. 14 is a flowchart to describe one example of SAF-low/CAF-low region processing in FIG. 13;

FIG. 15 is a flowchart to describe one example of SAF-high/CAF-low region processing in FIG. 13;

FIG. 16 is a flowchart to describe one example of SAF-low/CAF-high region processing in FIG. 13;

FIG. 17 is a flowchart to describe one example of SAF-high/CAF-high region processing in FIG. 13;

FIG. 18 is a flowchart to describe one example of A-low/M-high region processing in FIG. 11;

FIG. 19 is a flowchart to describe one example of DMF-low/MF-low region processing in FIG. 18;

FIG. 20 is a flowchart to describe one example of DMF-high/MF-low region processing in FIG. 18;

FIG. 21 is a flowchart to describe one example of DMF-low/MF-high region processing in FIG. 18;

FIG. 22 is a flowchart to describe one example of DMF-high/MF-high region processing in FIG. 18;

FIG. 23 is a flowchart to describe one example of A-high/M-high region processing in FIG. 11;

FIG. 24 is a diagram illustrating one example of the use history of four modes of a focus function;

FIG. 25 is a diagram to describe history information of a focus function;

FIG. 26 is a diagram to describe the flow of evaluation processing of the focus function proficiency level parameter 141;

FIG. 27 is a diagram to describe weighting coefficients and time lapse coefficients at the time of evaluating the focus function proficiency level parameter 141;

FIG. 28 is a flowchart to describe one example of evaluation processing of the focus function proficiency level parameter 141;

FIG. 29 is a schematic diagram to describe a variation example of time lapse coefficients;

FIG. 30 is a perspective view illustrating one example of an appearance configuration of the information processing apparatus 100;

FIG. 31 is a diagram to describe one example of a focus ring operation proficiency level parameter 142;

FIG. 32 is a diagram illustrating a variation example of an operation response according to the proficiency level of a focus ring operation;

FIG. 33 is a diagram illustrating one example of the operation history of a focus ring;

FIG. 34 is a diagram to describe history information of a focus ring operation;

FIG. 35 is a diagram to describe the flow of evaluation processing of the focus ring operation proficiency level parameter 142;

FIG. 36 is a diagram to describe weighting coefficients and time lapse coefficients at the time of evaluating the focus ring operation proficiency level parameter 142;

FIG. 37 is a flowchart to describe one example of evaluation processing of the focus ring operation proficiency level parameter 142;

FIG. 38 is a diagram to describe the flow of a normal setting operation of a recording mode;

FIG. 39 is a diagram to describe one example of a recording mode setting operation proficiency level parameter 143;

FIG. 40 is a diagram illustrating the relationships between the proficiency level of setting operations of an HD recording mode and an STD recording mode and transition patterns;

FIG. 41 is a diagram illustrating one example of transition patterns of selection screens based on the proficiency level;

FIG. 42 is a diagram illustrating the transition of a selection screen in the case of HD-LvL-STD-LvL-RecStepPattern;

FIG. 43 is a diagram illustrating the transition of a selection screen in the case of HD-LvL-STD-LvH-RecStepPattern;

FIG. 44 is a diagram illustrating the transition of a selection screen in the case of HD-LvH-STD-LvL-RecStepPattern;

FIG. 45 is a diagram illustrating the transition of a selection screen in the case of HD-LvH-STD-LvH-RecStepPattern;

FIG. 46 is a schematic diagram to describe the flow of transition pattern decision processing of selection screens of recording modes;

FIG. 47 is a flowchart to describe one example of decision processing of transition patterns of selection screens of recording modes;

FIG. 48 is a diagram illustrating one example of the history of a recording mode setting operation;

FIG. 49 is a diagram to describe history information of a recording mode setting operation;

FIG. 50 is a diagram to describe the flow of evaluation processing of the recording mode setting operation proficiency level parameter 143;

FIG. 51 is a diagram to describe weighting coefficients and time lapse coefficients at the time of evaluating the recording mode setting operation proficiency level parameter 143;

FIG. 52 is a flowchart to describe one example of evaluation processing of the recording mode setting operation proficiency level parameter 143;

FIG. 53 is a diagram illustrating one example of multiple content list views which can be displayed by the UI display unit 110;

FIG. 54 is a diagram to describe one example of a list view preference level parameter 144;

FIG. 55 is a diagram to describe the flow of a decision method of a default content list view;

FIG. 56 is a diagram illustrating one example of the use history of a calendar view, event view and map view;

FIG. 57 is a diagram to describe list view history information;

FIG. 58 is a diagram to describe the flow of evaluation processing of the list view preference level parameter 144;

FIG. 59 is a diagram to describe weighting coefficients at the time of evaluating the list view preference level parameter 144; and

FIG. 60 is a flowchart to describe one example of evaluation processing of list view preference level parameters.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Explanation is given in the following order:

1. Configuration example of information processing apparatus
2. User registration processing
3. User identification processing
4. Automatic customization of display/operation performance
4-1. Change by proficiency level of display content of help information
4-2. Automatic adjustment by proficiency level of operation response of focus ring
4-3. Simplification of operation step by proficiency level of recording mode setting
4-4. Setting of default list view based on preference level of list view

### 5. Conclusion

### 1. CONFIGURATION EXAMPLE OF INFORMATION PROCESSING APPARATUS

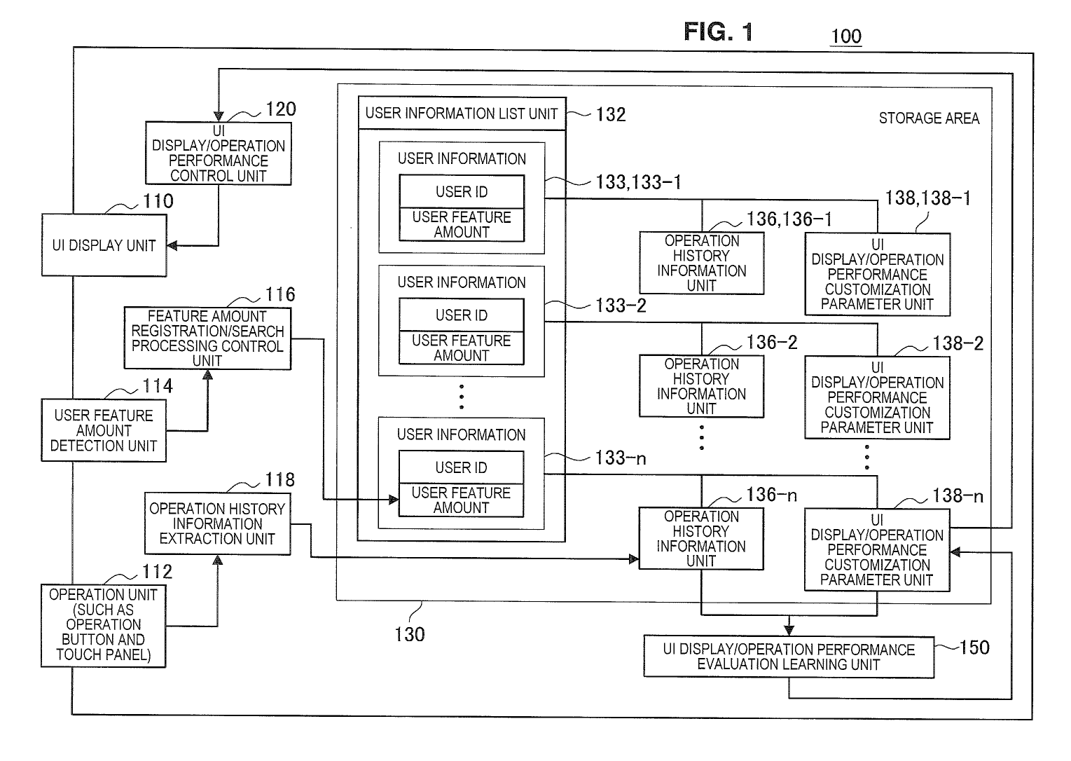

The function configuration example of the information processing apparatus 100 according to one embodiment of the present disclosure is described with reference to FIG. 1. Although the information processing apparatus 100 is an imaging apparatus such as a digital camera that can take an image of the user who is the object in the present embodiment, it is not limited to this and may be a portable terminal that can be operated by the user, for example.

FIG. 1 is a block diagram illustrating a function configuration example of the information processing apparatus 100 according to one embodiment of the present disclosure. As illustrated in FIG. 1, the information processing apparatus 100 includes the UI display unit 110, an operation unit 112, a user feature amount detection unit 114, a feature amount registration/search processing control unit 116, an operation history information extraction unit 118, a UI display/operation performance control unit 120, a storage area 130 and a UI display/operation performance evaluation learning unit 150.

(UI Display Unit 110)

The UI display unit 110 displays a menu screen or an operation screen, and so on. Moreover, the UI display unit 110 can display various kinds of information such as help information related to operations. The UI display unit 110 includes a display apparatus such as a liquid crystal display and an organic EL display.

(Operation Unit 112)

The operation unit 112 has a function to accept a user's operation input. The user selects a desired item in a menu screen by the operation unit 112. The operation unit 112 includes an operation button and a touch panel, and so on.

(User Feature Amount Detection Unit 114)

The user feature amount detection unit 114 has a function to detect the feature amount of the user who operates the information processing apparatus 100. The information processing apparatus 100 can be operated by a plurality of users. Therefore, in the present embodiment, the user's feature amount is detected to specify the user who operates it. For example, the user feature amount detection unit 114 includes an imaging unit that images the object user, and detects the feature amount of the user's face.

Here, in the above description, although the user feature amount detection unit 114 to detect the feature amount of the user's face by the imaging unit as a user feature amount, it is not limited to this, and, for example, a user's fingerprint may be detected as a user's feature amount. For example, the user's fingerprint is detected by the grip part or touch panel of the digital camera corresponding to the information processing apparatus 100. Moreover, the user feature amount may be a user's retinal pattern detected by the imaging unit.

(Feature Amount Registration/Search Processing Control Unit 116)

The feature amount registration/search processing control unit 116 has a function to register the feature amount of the user who operates the information processing apparatus 100 in a user information list unit 132 of the storage area 130. To be more specific, the feature amount registration/search processing control unit 116 registers user information that associates the user's feature amount and the user ID in the user information list unit 132.

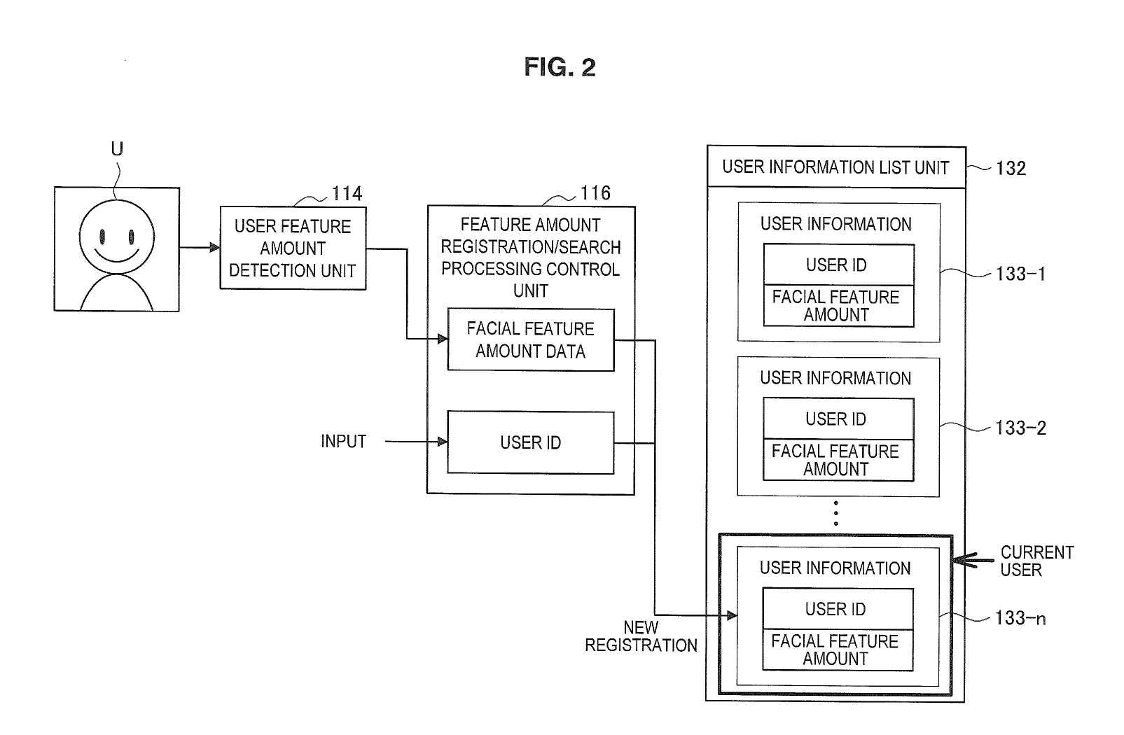

FIG. 2 is a schematic diagram to describe the flow of user registration processing. In the user registration processing, first, the user feature amount detection unit 114 detects the facial feature amount of user U by a camera. Next, the feature amount registration/search processing control unit 116 newly registers the detected facial feature of user U and the user ID input by the operation unit 112 in association with each other in the user information list unit 132. Subsequently, the newly registered user information is set as the current user who is currently operating the information processing apparatus 100. In FIG. 2, user information 133-n is set as the current user.

Moreover, the feature amount registration/search processing control unit 116 has a function to search for user information matching the user's feature amount from the user information group in the user information list unit 132.

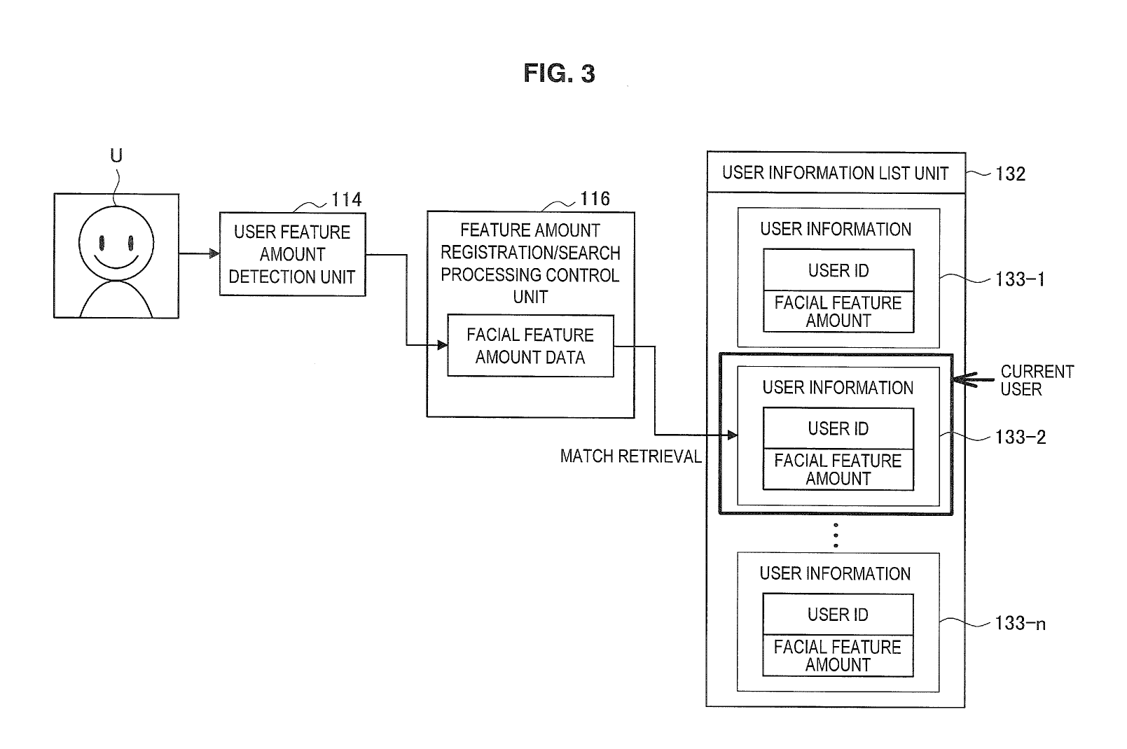

FIG. 3 is a schematic diagram to describe the flow of user identification processing. In the user identification processing, first, the user feature amount detection unit 114 detects the facial feature amount of user U by a camera. Next, the feature amount registration/search processing control unit 116 searches for user information matching the detected facial feature amount of user U among user information 133-1 to 133-n in the user information list unit 132. Subsequently, the user information matching the facial feature amount is set as the current user who is currently operating the information processing apparatus 100. In FIG. 3, user information 133-2 is set as the current user.

(Operation History Information Extraction Unit 118)

The operation history information extraction unit 118 extracts information about the operation history by the operation unit 112 of the user. For example, the operation history information extraction unit 118 extracts information about the history of a setting operation of a focus function.

(UI Display/Operation Performance Control Unit 120)

The UI display/operation performance control unit 120 performs display control by the UI display unit 110 and user's input control by the operation unit 112.

(Storage Area 130)

The storage area 130 stores various kinds of information. The storage area 130 includes the user information list unit 132, an operation history information unit 136 and a customization parameter unit 138. As illustrated in FIG. 1, the user information list unit 132, the operation history information unit 136 and the customization parameter unit 138 are set by each user.

The user information list unit 132 stores the user ID and the user feature amount in association with each other. The operation history information unit 136 stores information about the operation history extracted by the operation history information extraction unit 118. The customization parameter unit 138 stores parameters related to the display setting of the UI display unit 110 and the operation setting by the operation unit 112.

Thus, the storage area 130 stores operation history information for each of multiple users who can operate the information processing apparatus 100. Moreover, the storage area 130 records variable setting parameters of the apparatus for each of the multiple users who can operate the information processing apparatus 100. As a result of this, it is possible to set setting parameters based on the operation history for each user.

(UI Display/Operation Performance Evaluation Learning Unit 150)

The UI display/operation performance evaluation learning unit 150 changes the setting of the information processing apparatus 100 on the basis of operation history information about the operation history of the information processing apparatus 100. As a result of this, it is possible to change the setting so as to reflect the user's operation history.

The UI display/operation performance evaluation learning unit 150 acquires time lapse information about a time lapse. Subsequently, the UI display/operation performance evaluation learning unit 150 combines the time lapse information and the operation history information, and changes the setting of the information processing apparatus 100. As a result of this, since the time lapse of the operation history is considered, it is possible to change the setting so as to adequately reflect the user's operation state at the current time.

The setting of the information processing apparatus 100 relates to the setting of a user interface of the information processing apparatus 100. Here, the setting of the user interface may be the setting of a list view (for example, a calendar view or event view described later) to display a list of content in the UI display unit 110. Alternatively, the setting of the user interface may be the setting (for example, display of help information described later) related to imaging by the imaging unit. Moreover, the setting of the information processing apparatus 100 may relate to imaging parameters (for example, response level to a focus ring operation described later) at the time of imaging by the imaging unit. As a result of this, various settings reflecting the user's operation history are automatically changed.

The UI display/operation performance evaluation learning unit 150 executes either the first mode to combine the time lapse information and the operation history information and change the setting of the information processing apparatus 100 or the second mode to change the setting of the information processing apparatus 100 on the basis of the operation history information. As a result of this, by selecting a mode suitable to the situation, it is possible to appropriately change the setting of the information processing apparatus 100.

The UI display/operation performance evaluation learning unit 150 estimates the operation proficiency level on the basis of the operation history information and changes the setting of the information processing apparatus 100. As a result of this, it is possible to automatically change the setting so as to reflect the proficiency level of the user's operation.

The UI display/operation performance evaluation learning unit 150 changes the setting value of the information processing apparatus 100 on the basis of the above-mentioned operation history information, and, in a case where the time lapse is long, the UI display/operation performance evaluation learning unit 150 may return the above-mentioned setting value to the original value. As a result of this, even if the operation has been performed in the past, it is possible to change the setting so as to reflect the user's proficiency level at the current more.

### 2. USER REGISTRATION PROCESSING

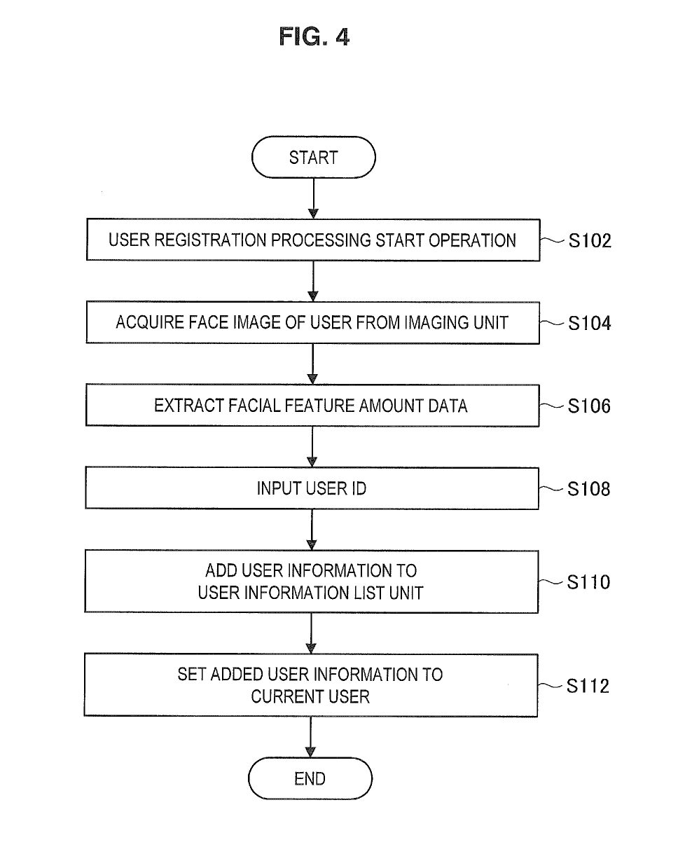

User registration processing is described with reference to FIG. 4. FIG. 4 is a flowchart to describe one example of the user registration processing. The flowchart in FIG. 4 starts from a step in which the user of the information processing apparatus 100 selects a user registration start operation in a menu screen (step S102).

Next, by imaging the user's face by the imaging unit of the user feature amount detection unit 114, the feature amount registration/search processing control unit 116 acquires user's face information (step S104). Subsequently, the feature amount registration/search processing control unit 116 extracts facial feature amount data (step S106).

Next, the feature amount registration/search processing control unit 116 acquires the user ID input by the user using the operation unit 112 (step S108). Next, the feature amount registration/search processing control unit 116 adds user information associating the facial feature amount data extracted in step S106 and the user ID acquired in and step S108, to the user information list unit 132 (step S110). Subsequently, the feature amount registration/search processing control unit 116 sets the user information added in step S110 as the current user (step S112).

### 3. USER IDENTIFICATION PROCESSING

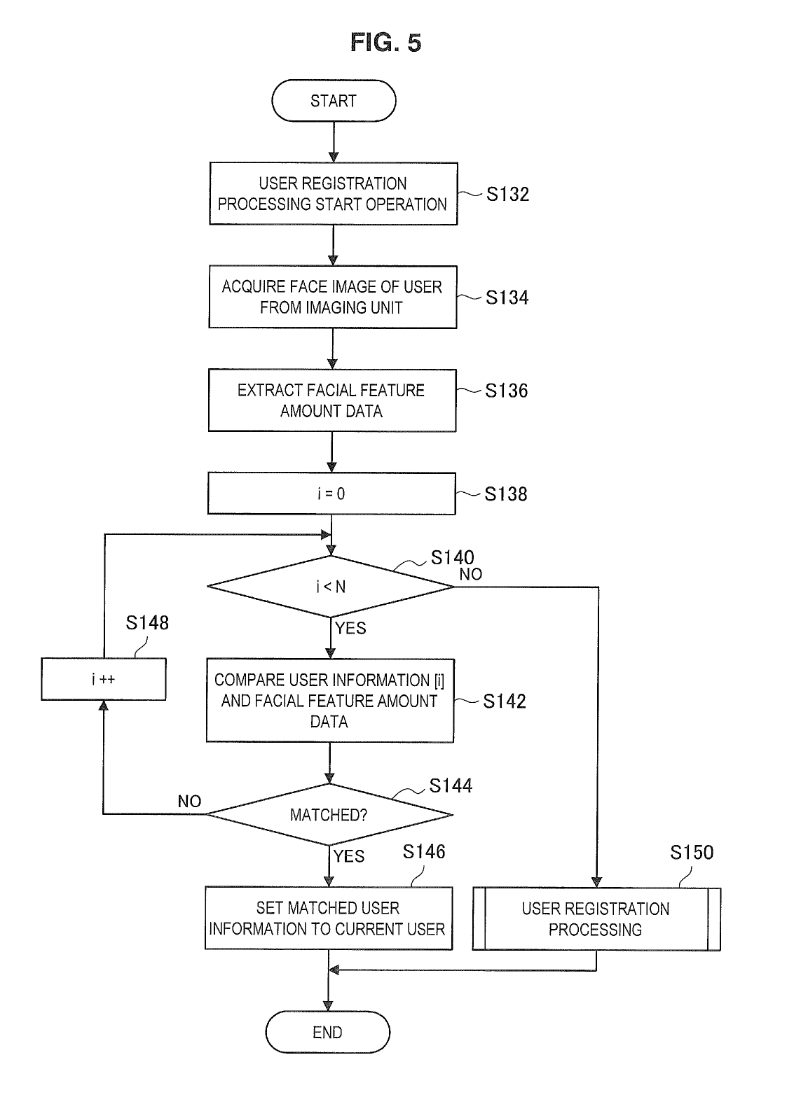

User identification processing is described with reference to FIG. 5. FIG. 5 is a flowchart to describe the user identification processing. The flowchart in FIG. 5 starts from a step in which the user of the information processing apparatus 100 selects a user identification processing start operation in a menu screen (step S132).

Next, by imaging the user's face by the imaging unit of the user feature amount detection unit 114, the feature amount registration/search processing control unit 116 acquires use's face information (step S134). Subsequently, the feature amount registration/search processing control unit 116 extracts facial feature amount data (step S136).

Next, the feature amount registration/search processing control unit 116 sets “i” (where “i” is an integer equal to or greater than 0) to be equal to 0 (step S138). Next, the feature amount registration/search processing control unit 116 determines whether “i” is smaller than registration number N of users registered in the user information list unit 132 (step S140).

In a case where “i” is smaller than N in step S140 (Yes), the feature amount registration/search processing control unit 116 compares user information [i] of the user information list unit 132 and the facial feature amount data extracted in step S136 (step S142). As a result of the comparison, in a case where there is user information matching the facial feature amount data in the user information list unit 132 (step S144: Yes), the feature amount registration/search processing control unit 116 sets the matching user information as the current user (step S146).

On the other hand, in a case where there is no user information matching the facial feature amount data in the user information list unit 132 in step S144 (No), the feature amount registration/search processing control unit 116 increments “i” by 1 (step S148) and repeats the processing in step 140 and subsequent steps. Moreover, in a case where “i” is not smaller than N in step S140 (No), the feature amount registration/search processing control unit 116 identifies a new user and performs the user registration processing illustrated in FIG. 4 (step S150).

### 4. AUTOMATIC SETTING OF DISPLAY/OPERATION PERFORMANCE

In the present embodiment, the information processing apparatus 100 changes the setting of the display/operation performance of the information processing apparatus 100 according to the display and operation situation. As a result of this, even if the user does not customize the setting of the display/operation performance, it is automatically changed. Moreover, in the present embodiment, by changing the setting of the display/operation performance for each user, it is changed to the setting of the display/operation performance suitable for the user who is using the information processing apparatus 100 at the current time.

In the following, an explanation is given using: the change of display content of help information according to the proficiency level; automatic adjustment of an operation response of a focus ring according to the proficiency level; simplification of an operation step of the recording mode setting according to the proficiency level; and the setting of a default list view according to the preference level of the list view, as an automatic setting example of the display/operation performance.

(4-1. Change of Display of Help Information According to Proficiency Level)

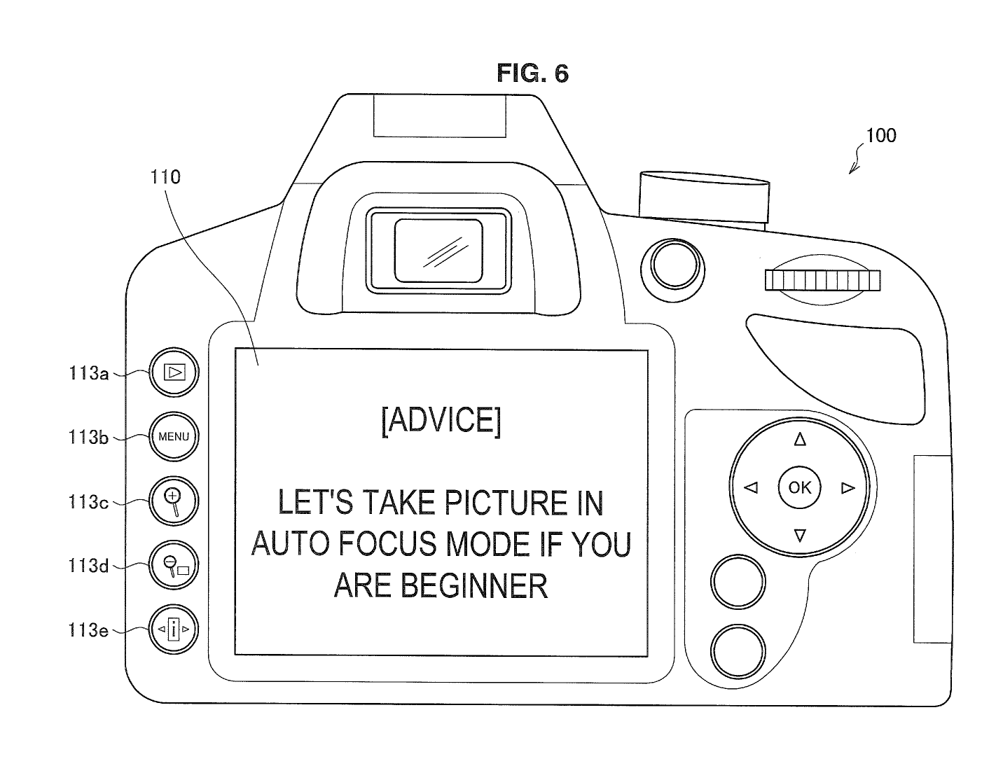

FIG. 6 is a diagram to describe help information displayed on the UI display unit 110 of the information processing apparatus 100. As illustrated in FIG. 6, the UI display unit 110 and various buttons 113a to 113e forming the operation unit 112 are installed on the back side of the digital camera of the information processing apparatus 100. When the user presses the help button 113d while a menu screen or the like in the UI display unit 110 is displayed, help information is displayed. In the following, as the help information, an explanation is given using help information of a focus function to focus the camera as an example.

Modes of the focus function are divided into auto (automatic operation) focus modes and manual (manual operation) focus modes. In addition, the auto focus modes are divided into a single auto focus (which may be referred to as “SAF”) mode and a continuous focus (which may be referred to as “CAF”) mode. The single auto focus mode is a mode that fixes the focus when the focus is suitable. The continuous focus mode is a mode that keeps focusing the camera during the half-press state of a shutter button.

The manual focus modes are divided into a direct manual focus (which may be referred to as “DMF”) mode that is a mode that combines and uses the manual focus and the auto focus, and a manual focus (which may be referred to as “MF”) mode that is the mode to focus the camera by hand.

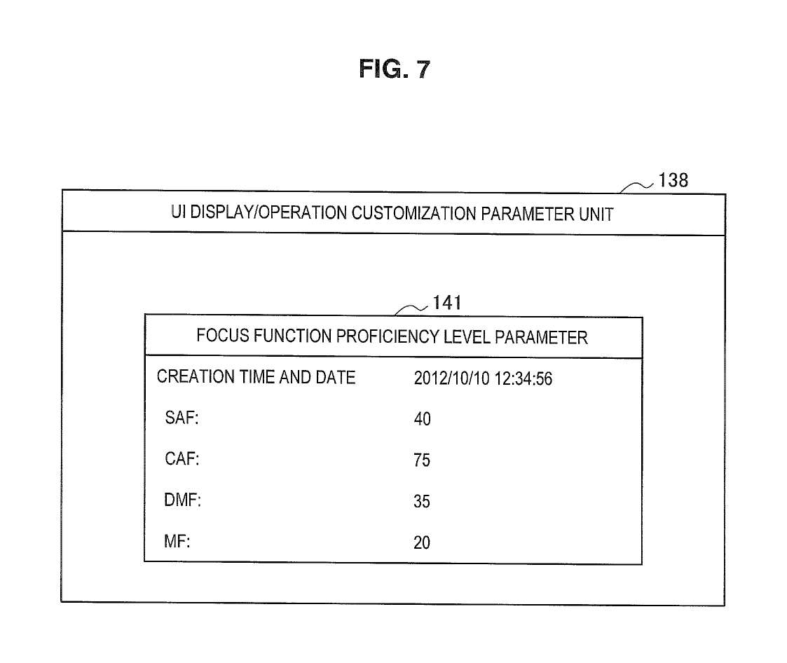

Regarding the display of help information of the focus function, the customization parameter unit 138 illustrated in FIG. 1 has the focus function proficiency level parameter 141 as illustrated in FIG. 7.

FIG. 7 is a diagram to describe the focus function proficiency level parameter 141. As illustrated in FIG. 7, the focus function proficiency level parameter 141 includes information about the creation time and date of parameters and the proficiency level of each of four modes (SAF, CAF, DMF and MF) of the focus function. The proficiency level is quantified, and the numerical value of the proficiency level is larger in a mode with higher use frequency.

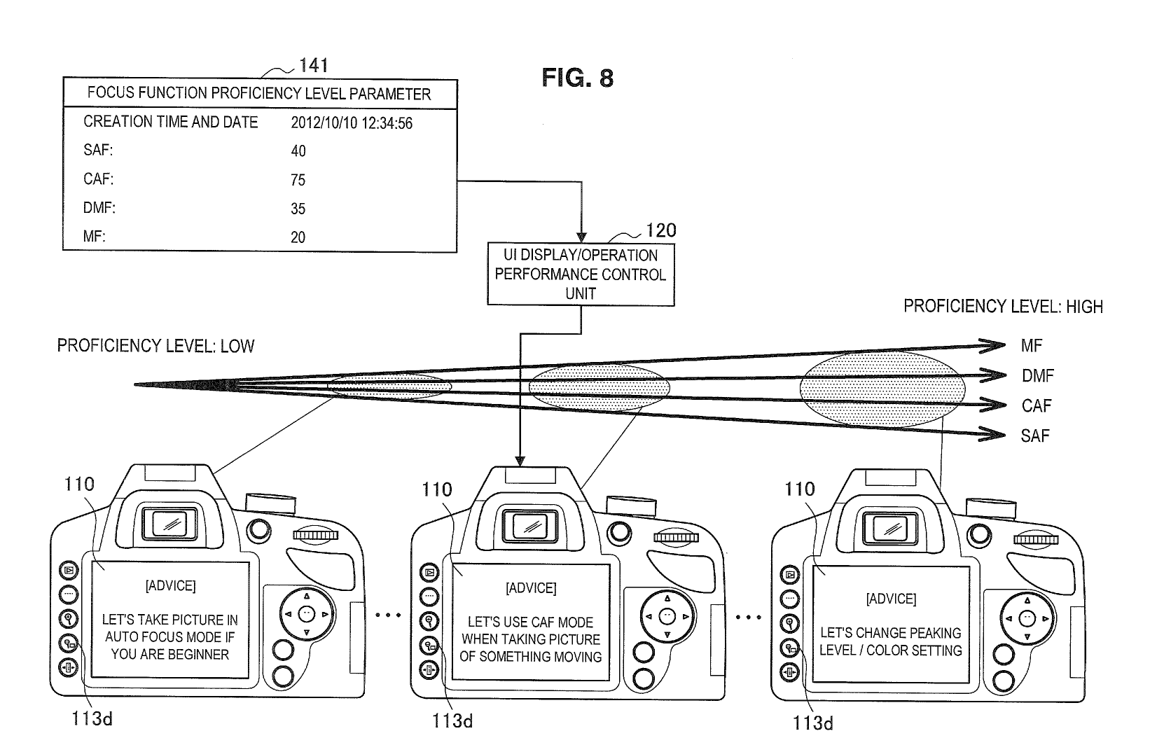

When the focus function is used, as illustrated in FIG. 8, the UI display/operation performance control unit 120 illustrated in FIG. 1 changes the content of help information displayed on the UI display unit 110 according to the numerical value of the proficiency level of the focus function proficiency level parameter 141.

FIG. 8 is a diagram illustrating a display example of the help information of the focus function according to the focus function proficiency level. As illustrated in FIG. 8, more advanced content is displayed as the help information when the numerical value of the proficiency level in four modes is larger.

In the present embodiment, a plurality of items of help information (help information group) is set in advance for each of the four modes. The plurality of items of help information denotes information showing help/advice based on the proficiency level of the focus function, and the display content in the UI display unit 110 varies.

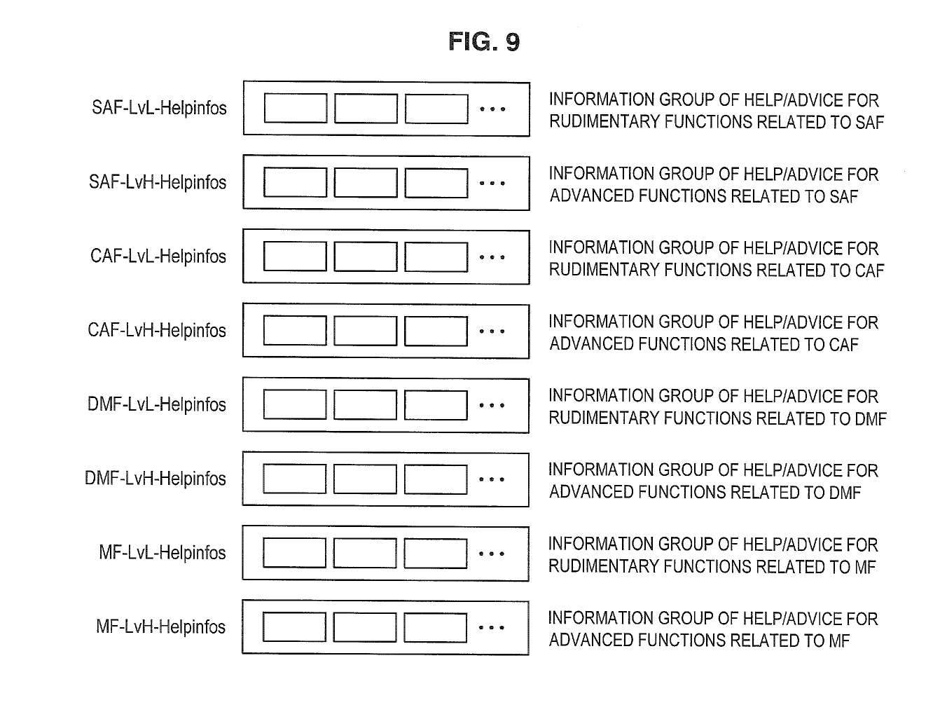

FIG. 9 is a diagram to describe the help information group for each of the four modes of the focus function. As illustrated in FIG. 9, a help information group including multiple items of help information of rudimentary functions and a help information group including multiple items of help information of advanced functions are set for each of the four modes, that is, a single auto focus (SAF) mode, a continuous focus (CAF) mode, a direct manual focus (DMF) mode and a manual focus (MF) mode. For example, SAF-LvL-Helpinfos illustrated in FIG. 9 is a help/advice information group for rudimentary functions related to SAF, and SAF-LvH-Helpinfos is an advanced help/advice information group related to SAF. Also, in FIG. 9, although two kinds of information groups are set for each mode, it is not limited to this, and, for example, three or more kinds of information groups may be set for each mode.

The UI display/operation performance control unit 120 selects help information based on the proficiency level from the help information groups.

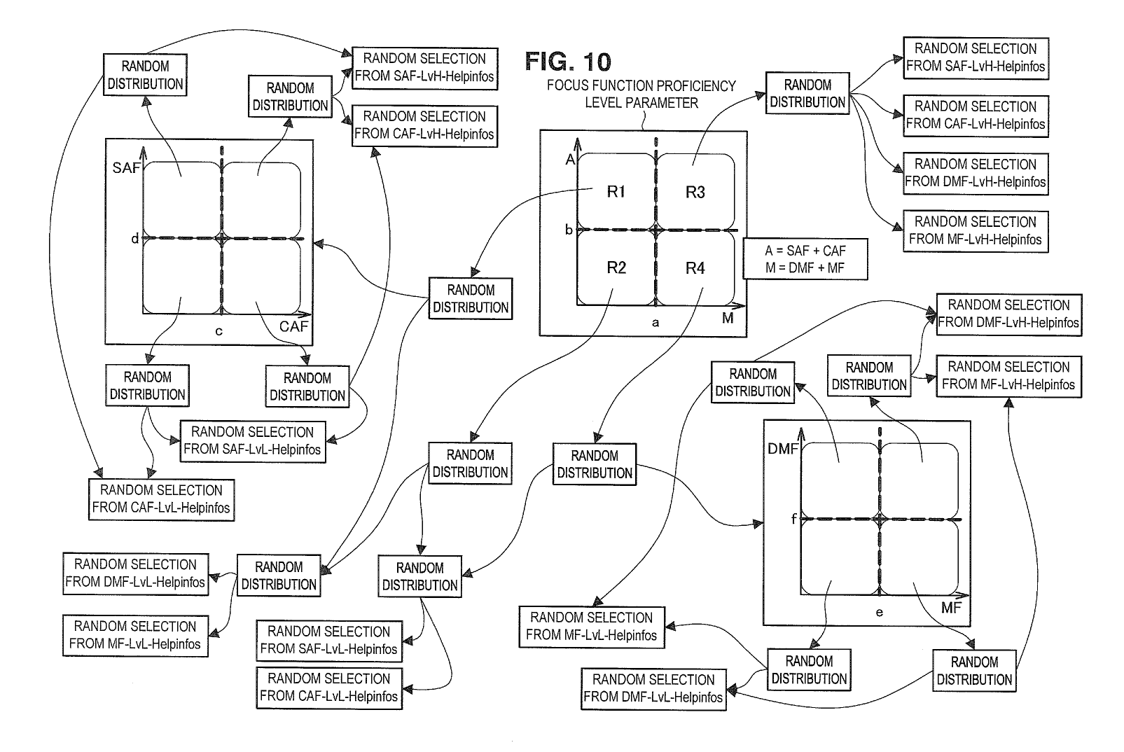

FIG. 10 is a schematic diagram to describe the flow of decision processing of help information of the focus function. First, the UI display/operation performance control unit 120 determines a relative relationship of the proficiency levels of the manual focus (including DMF and MF) and the auto focus (including SAF and CAF), on the basis of the focus function proficiency level parameter 141. To be more specific, the UI display/operation performance control unit 120 determines to which four regions R1, R2, R3 and R4 illustrated in FIG. 10 it corresponds. The horizontal axis of the graph illustrated in FIG. 10 shows the proficiency level of the manual focus and the vertical axis shows the proficiency level of the auto focus. Further, when the corresponding region is decided, the UI display/operation performance control unit 120 performs random branch processing (which is described later in detail) and selects optimal help information from among the help information groups described in FIG. 9.

(Decision Processing of Help Information of Focus Function)

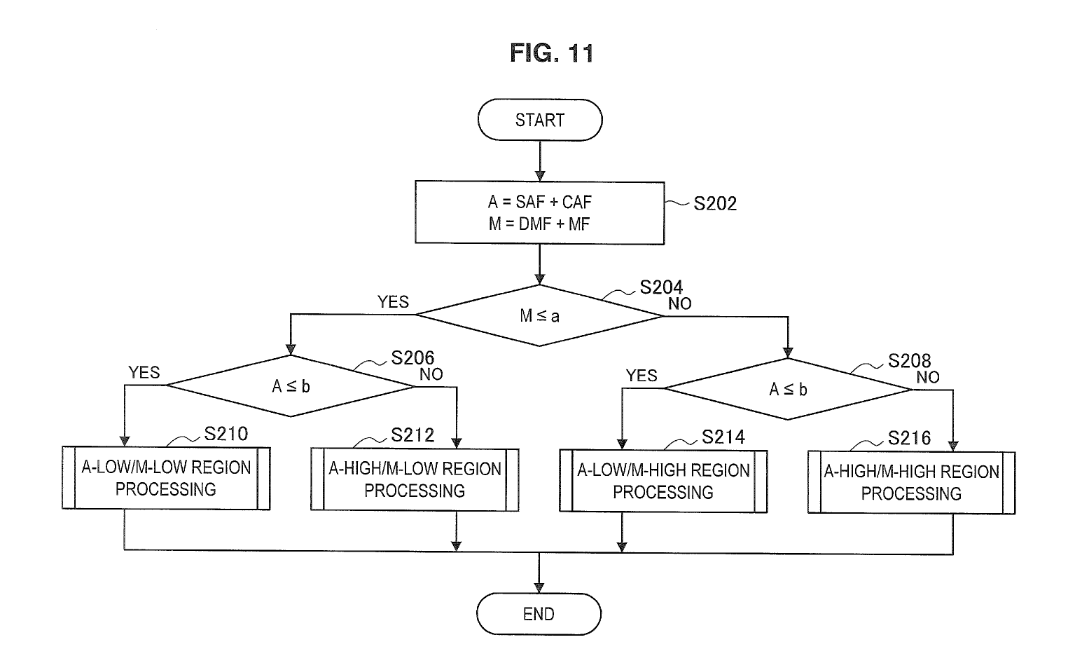

Here, specific decision processing of help information of the focus function is described with reference to FIG. 11 to FIG. 23.

FIG. 11 is a flowchart to describe one example of the decision processing of help information of the focus function. The flowchart in FIG. 11 starts from a step in which the UI display/operation performance control unit 120 acquires the values of the proficiency levels of the four modes (SAF, CAF, DMF and MF) of the focus function proficiency level parameters.

In the flowchart of FIG. 11, first, the UI display/operation performance control unit 120 calculates numerical value A adding the proficiency level values of SAF and CAF of the auto focus, and numerical value M adding the proficiency level values of DMF and MF of the manual focus (step S202). Next, the UI display/operation performance control unit 120 determines whether numerical value M is equal to or less than predetermined threshold “a” (step S204). Threshold “a” is a threshold for the proficiency level of the manual focus and is set in advance.

In a case where numerical value M is equal to or less than threshold “a” in step S204 (Yes), the UI display/operation performance control unit 120 determines whether numerical value A is equal to or less than threshold b (step S206). Threshold b is a threshold for the proficiency level of the auto focus and is set in advance. Subsequently, in a case where numerical value A is equal to or less than threshold b in step S206, (Yes), the UI display/operation performance control unit 120 performs A-low/M-low region processing (step S210).

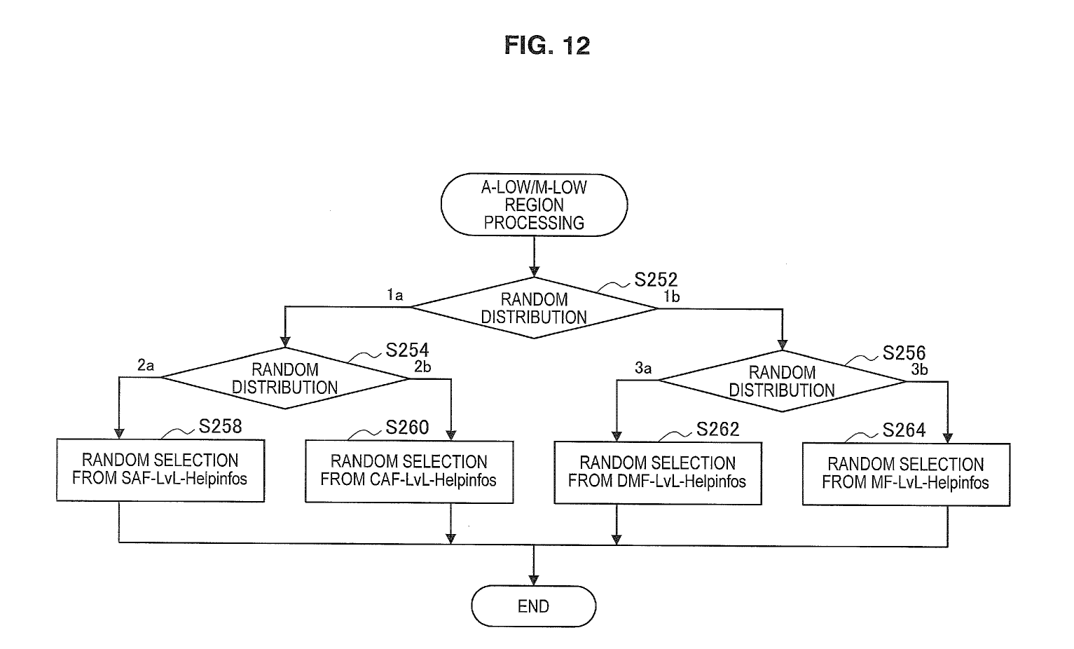

FIG. 12 is a flowchart to describe one example of the A-low/M-low region processing in FIG. 11. First, in the flowchart of FIG. 12, the UI display/operation performance control unit 120 performs random branch processing that randomly selects the branch destination from two branch destinations 1a and 1b (step S252). The random branch processing denotes processing that selects the branch destination 1a or 1b with a probability of 50%.

In a case where the branch destination 1a is selected in step S252, the UI display/operation performance control unit 120 further performs random branch processing that randomly selects one branch destination from two branch destinations 2a and 2b (step S254). Subsequently, in a case where the branch destination 2a is selected in step S254, the UI display/operation performance control unit 120 selects one help information from SAF-LvL-Hinfos (which is the rudimentary help information group about SAF) illustrated in FIG. 9 (step S258). On the other hand, in a case where the branch destination 2b is selected in step S254, the UI display/operation performance control unit 120 selects one help information from CAF-LvL-Hinfos (which is the rudimentary help information group about CAF) (step S260).

In a case where the branch destination 1b is selected in above-mentioned step S252, the UI display/operation performance control unit 120 further performs random branch processing that randomly selects one branch destination from two branch destinations 3a and 3b (step S256). Subsequently, in a case where the branch destination 3a is selected in step S256, the UI display/operation performance control unit 120 selects one help information from DMF-LvL-Hinfos (which is the rudimentary help information group about DMF) (step S262). On the other hand, in a case where the branch destination 3b is selected in step S256, the UI display/operation performance control unit 120 selects one help information from MF-LvL-Hinfos (which is the rudimentary help information group about MF) (step S264).

By performing A-low/M-low region processing described above, it is possible to select help information based on the proficiency level from four of SAF-LvL-Hinfos, CAF-LvL-Hinfos, DMF-LvL-Hinfos and MF-LvL-Hinfos, with a probability of 25%.

Returning to FIG. 11, the explanation of the decision processing of help information of the focus function is continued. In a case where numerical value A is not equal to or less than threshold b in step S206 (No), the UI display/operation performance control unit 120 performs A-high/M-low region processing (step S212).

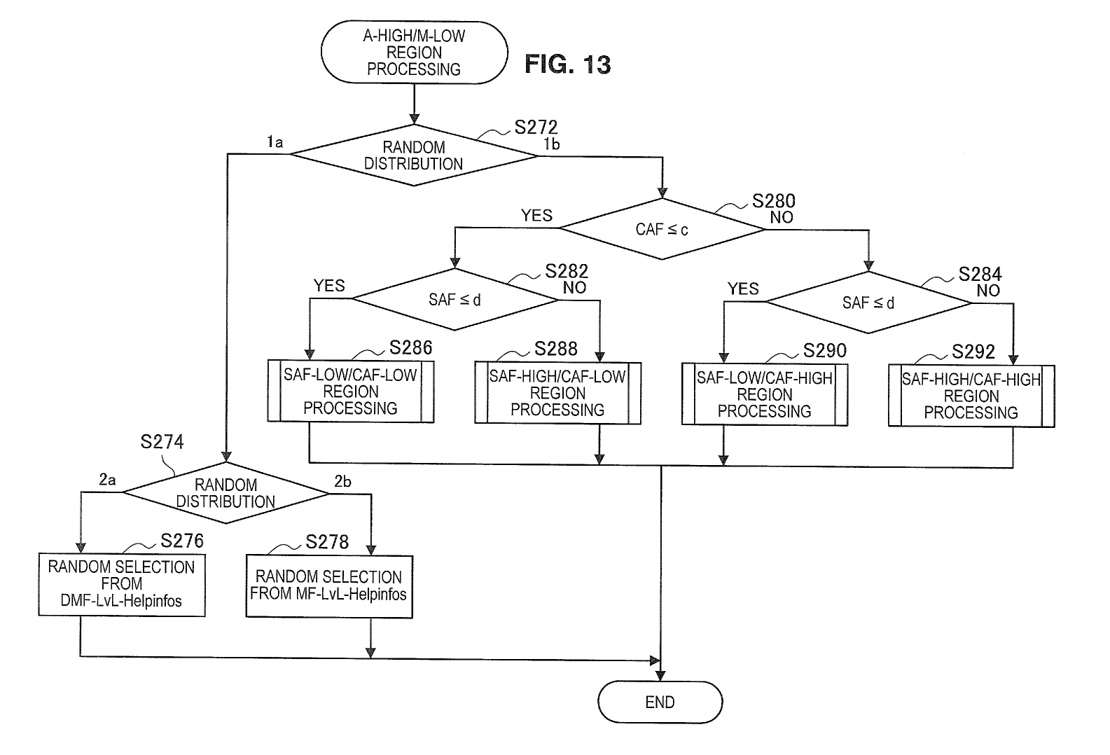

FIG. 13 is a flowchart to describe one example of the A-high/M-low region processing in FIG. 11. First, in the flowchart of FIG. 13, the UI display/operation performance control unit 120 performs random branch processing that randomly selects one branch destination from two branch destinations 1a and 1b (step S272). In a case where the branch destination 1a is selected in step S272, the UI display/operation performance control unit 120 further performs random branch processing that randomly selects one branch destination from the two branch destinations 2a and 2b (step S274).

Subsequently, in a case where the branch destination 2a is selected in step S274, the UI display/operation performance control unit 120 selects one help information from DMF-LvL-Hinfos (which is the rudimentary help information group about DMF) (step S276). On the other hand, in a case where the branch destination 2b is selected in step S274, the UI display/operation performance control unit 120 selects one help information from MF-LvL-Hinfos (which is the rudimentary help information group about MF) (step S278).

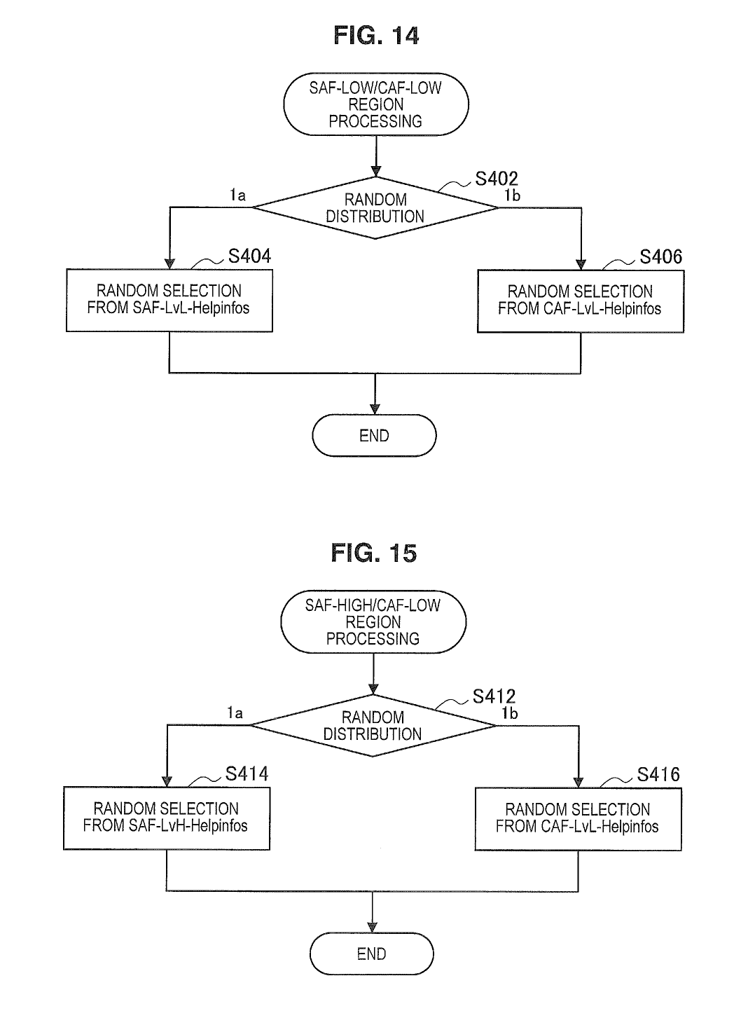

In a case where the branch destination 1b is selected in above-mentioned step S272, the UI display/operation performance control unit 120 determines whether the value of CAF is equal to or less than predetermined threshold c (step S280). In a case where it is determined that the value of CAF is equal to or less than threshold c in step S280 (Yes), the UI display/operation performance control unit 120 further determines whether the value of SAF is equal to or less than threshold d (step S282). In a case where it is determined that the value of SAF is equal to or less than threshold d in step S282 (Yes), the UI display/operation performance control unit 120 performs SAF-low/CAF-low region processing illustrated in FIG. 14 (step S286).

FIG. 14 is a flowchart to describe one example of the SAF-low/CAF-low region processing in FIG. 13. The UI display/operation performance control unit 120 performs random branch processing (step S402), selects one help information from SAF-LvL-Hinfos in a case where the branch destination 1a is selected (step S404), and selects one help information from CAF-LvL-Hinfos in a case where the branch destination 2a is selected (step S406).

On the other hand, in a case where it is determined that the value of SAF is not equal to or less than threshold d in step S282 (No), the UI display/operation performance control unit 120 performs SAF-high/CAF-low region processing illustrated in FIG. 15 (step S288).

FIG. 15 is a flowchart to describe one example of the SAF-high/CAF-low region processing in FIG. 13. The UI display/operation performance control unit 120 performs random branch processing (step S412), selects one help information from SAF-LvH-Hinfos (which is the advanced help information group about SAF) in a case where the branch destination 1a is selected (step S414), and selects one help information from CAF-LvL-Hinfos in a case where the branch destination 2a is selected (step S416).

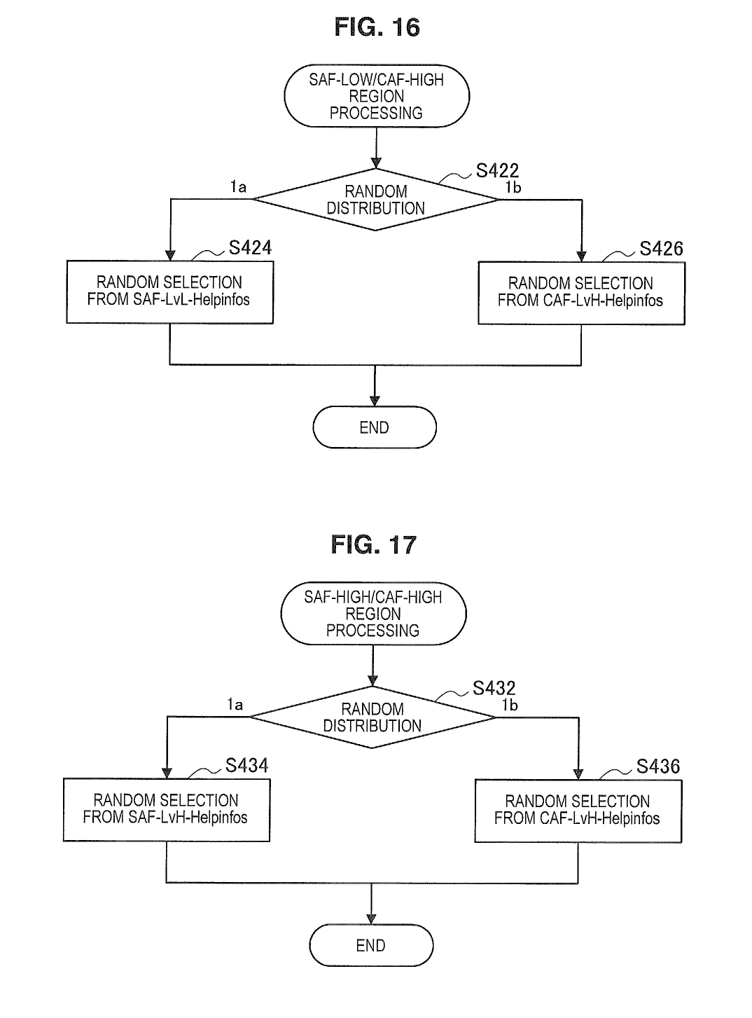

In a case where it is determined that the value of CAF is equal to or less than threshold c in above-mentioned step S280 (No), the UI display/operation performance control unit 120 further determines whether the value of SAF is equal to or less than threshold d (step S284). Subsequently, in a case where it is determined that the value of SAF is equal to or less than threshold d in step S284 (Yes), the UI display/operation performance control unit 120 performs SAF-low/CAF-high region processing illustrated in FIG. 16 (step S290).

FIG. 16 is a flowchart to describe one example of the SAF-low/CAF-high region processing in FIG. 13. The UI display/operation performance control unit 120 performs random branch processing (step S422), selects one help information from SAF-LvL-Hinfos in a case where the branch destination 1a is selected (step S424), and selects one help information from CAF-LvH-Hinfos (which is the advanced help information group about CAF) in a case where the branch destination 2a is selected (step S426).

On the other hand, in a case where it is determined that the value of SAF is not equal to or less than threshold d in step S284 (No), the UI display/operation performance control unit 120 performs SAF-high/CAF-high region processing illustrated in FIG. 17 (step S292).

FIG. 17 is a flowchart to describe one example of the SAF-high/CAF-high region processing in FIG. 13. The UI display/operation performance control unit 120 performs random branch processing (step S432), selects one help information from SAF-LvH-Hinfos in a case where the branch destination 1a is selected (step S434), and selects one help information from CAF-LvH-Hinfos in a case where the branch destination 2a is selected (step S436).

By performing the A-high/M-low region processing described above, help information based on the proficiency level is randomly selected from DMF-LvL-Hinfos, MF-LvL-Hinfos, SAF-LvL-Hinfos, SAF-LvH-Hinfos, CAF-LvL-Hinfos and CAF-LvH-Hinfos.

Returning to FIG. 11, the explanation of the decision processing of help information of the focus function is continued. In a case where value M is not equal to or less than threshold “a” in step S204 (No), the UI display/operation performance control unit 120 determines whether numerical value A is equal to or less than threshold b (step S208). Subsequently, when numerical value A is equal to or less than threshold b in step S208 (Yes), the UI display/operation performance control unit 120 performs A-low/M-high region processing (step S214).

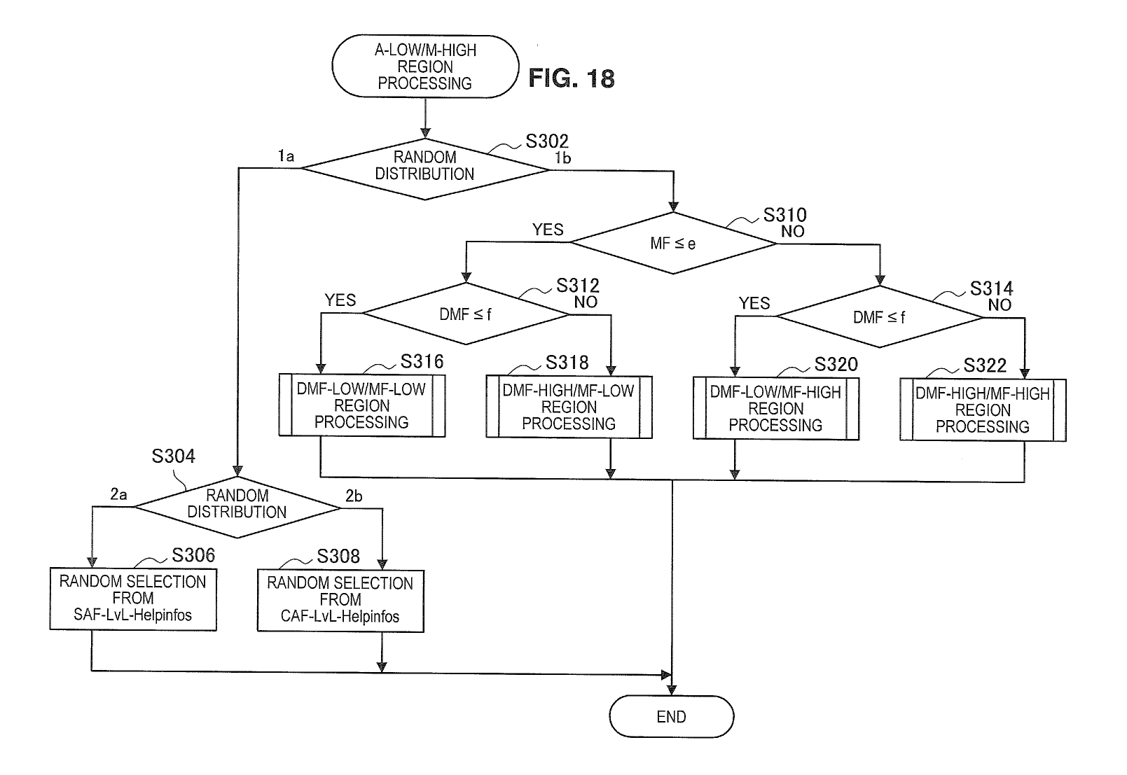

FIG. 18 is a flowchart to describe the A-low/M-high region processing in FIG. 11. In the flowchart of FIG. 18, first, the UI display/operation performance control unit 120 performs random branch processing that randomly selects one branch destination from the two branch destinations 1a and 1b (step S302). In a case where the branch destination 1a is selected in step S302, the UI display/operation performance control unit 120 further performs random branch processing that randomly selects one branch destination from the two branch destinations 2a and 2b (step S304).

Subsequently, in a case where the branch destination 2a is selected in step S304, the UI display/operation performance control unit 120 selects one help information from SAF-LvL-Hinfos (step S306). On the other hand, in a case where the branch destination 2b is selected in step S304, the UI display/operation performance control unit 120 selects one help information from CAF-LvL-Hinfos (step S308).

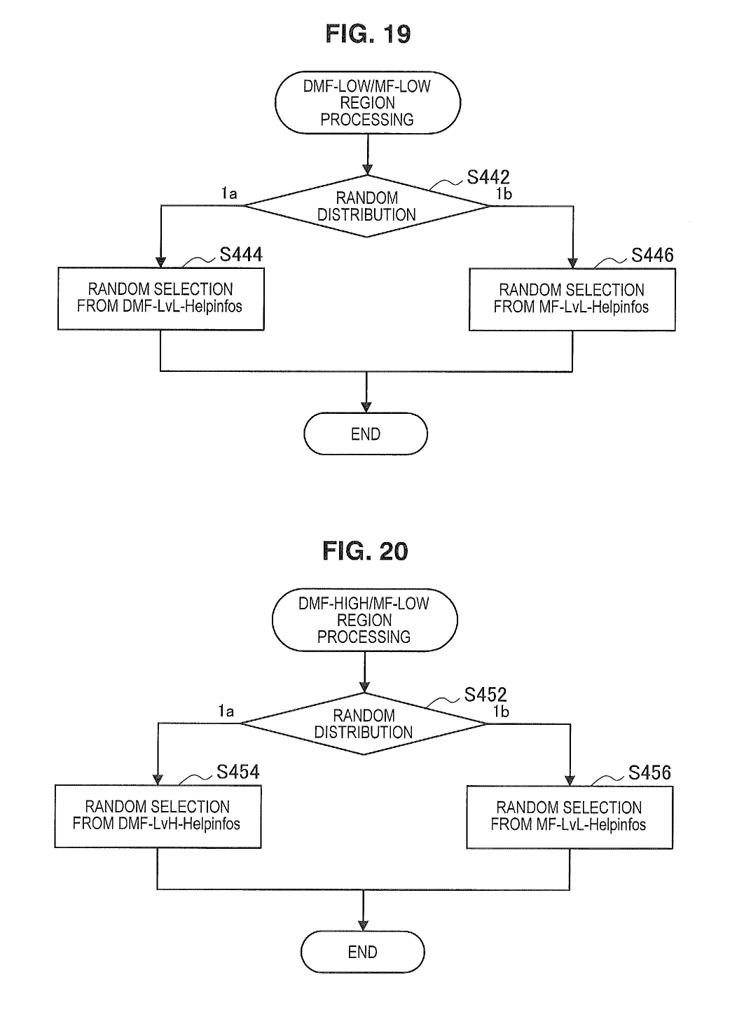

In a case where the branch destination 1b is selected in above-mentioned step S302, the UI display/operation performance control unit 120 determines whether the value of MF is equal or less than predetermined threshold p (step S310). In a case where it is determined that the value of MF is equal to or less than threshold p in step S310 (Yes), the UI display/operation performance control unit 120 further determines whether the value of DMF is equal to or less than threshold δ (step S312). In a case where it is determined that the value of DMF is equal to or less than threshold δ in step S312 (Yes), the UI display/operation performance control unit 120 performs DMF-low/MF-low region processing illustrated in FIG. 19 (step S316).

FIG. 19 is a flowchart to describe one example of the DMF-low/MF-low region processing in FIG. 18. The UI display/operation performance control unit 120 performs random branch processing (step S442), selects one help information from DMF-LvL-Hinfos in a case where the branch destination 1a is selected (step S444), and selects one help information from MF-LvL-Hinfos in a case where the branch destination 2a is selected (step S446).

On the other hand, in a case where it is determined that the value of DMF is not equal to or less than threshold 6 in step S312 (No), the UI display/operation performance control unit 120 performs DMF-high/MF-low region processing illustrated in FIG. 20 (step S318).

FIG. 20 is a flowchart to describe one example of the DMF-high/MF-low region processing in FIG. 18. The UI display/operation performance control unit 120 performs random branch processing (step S452), selects one help information from DMF-LvH-Hinfos in a case where the branch destination 1a is selected (step S454), and selects one help information from MF-LvL-Hinfos in a case where the branch destination 2a is selected (step S456).

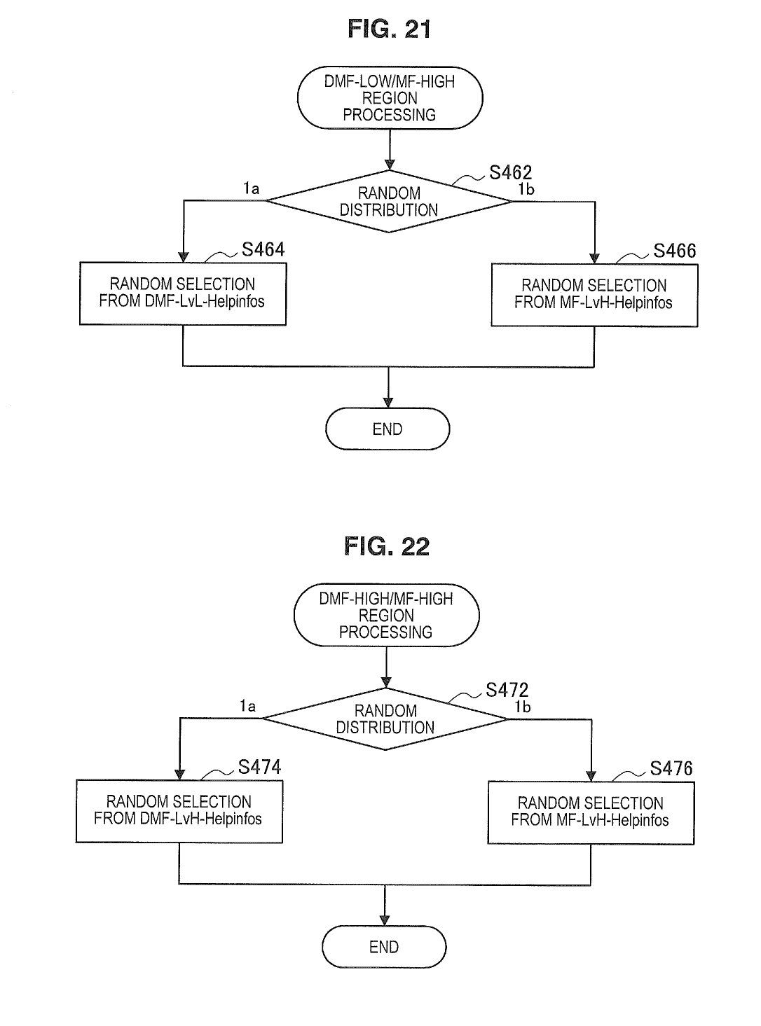

In a case where it is determined that the value of MF is not equal to or less than threshold p in above-mentioned step S310 (No), the UI display/operation performance control unit 120 further determines whether the value of DMF is equal to or less than threshold 6 (step S314). Subsequently, in a case where it is determined that the value of DMF is equal to or less than threshold 6 in step S314 (Yes), the UI display/operation performance control unit 120 performs DMF-low/MF-high region processing illustrated in FIG. 21 (step S320).

FIG. 21 is a flowchart to describe one example of the DMF-low/MF-high region processing in FIG. 18. The UI display/operation performance control unit 120 performs random branch processing (step S462), selects one help information from DMF-LvL-Hinfos in a case where the branch destination 1a is selected (step S464), and selects one help information from MF-LvH-Hinfos in a case where the branch destination 2a is selected (step S466).

On the other hand, in a case where it is determined that the value of DMF is not equal to or less than threshold 6 in step S314 (No), the UI display/operation performance control unit 120 performs DMF-high/MF-high region processing illustrated in FIG. 22 (step S322).

FIG. 22 is a flowchart to describe one example of the DMF-high/MF-high region processing in FIG. 18. The UI display/operation performance control unit 120 performs random branch processing (step S472), selects one help information from DMF-LvH-Hinfos in a case where the branch destination 1a is selected (step S474), and selects one help information from MF-LvH-Hinfos in a case where the branch destination 2a is selected (step S476).

By performing the A-low/M-high region processing described above, help information based on the proficiency level is randomly selected from SAF-LvL-Hinfos, CAF-LvL-Hinfos, DMF-LvL-Hinfos, DMF-LvH-Hinfos, MF-LvL-Hinfos and MF-LvH-Hinfos.

Returning to FIG. 11, the explanation of the decision processing of help information of the focus function is continued. In a case where numerical value A is not equal to or less than threshold b in step S208 (No), the UI display/operation performance control unit 120 performs A-high/M-high region processing (step S216).

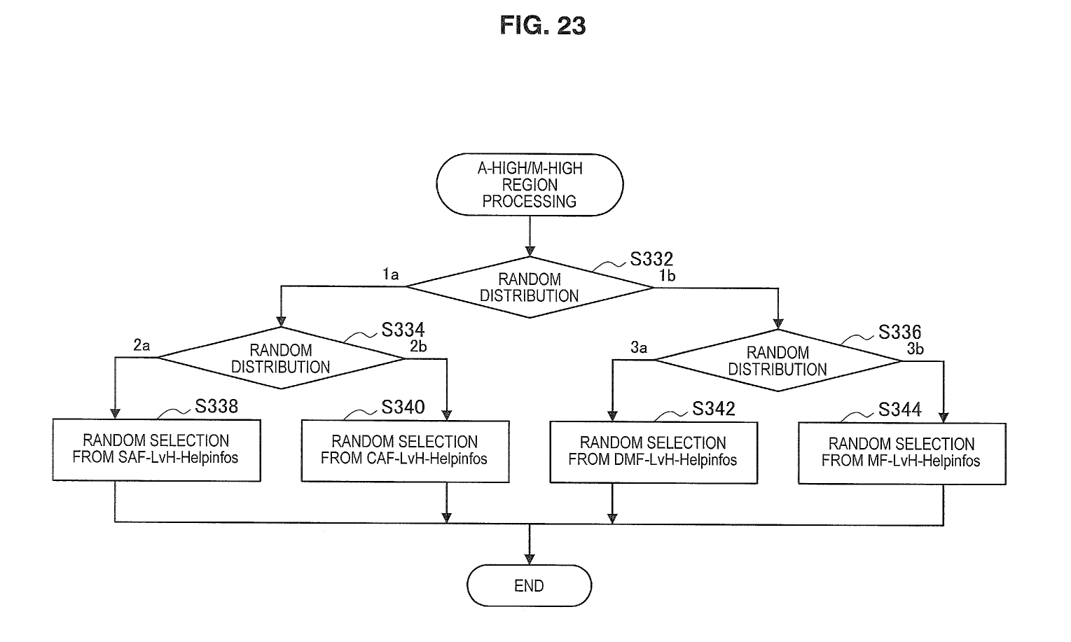

FIG. 23 is a flowchart to describe one example of the A-high/M-high region processing in FIG. 11. In the flowchart of FIG. 23, first, the UI display/operation performance control unit 120 performs random branch processing that randomly selects one branch destination from the two branch destinations 1a and 1b (step S332). In a case where the branch destination 1a is selected in step S332, the UI display/operation performance control unit 120 further performs random branch processing that randomly selects one branch destination from the two branch destinations 2a and 2b (step S334).

Subsequently, in a case where the branch destination 2a is selected in step S334, the UI display/operation performance control unit 120 selects one help information from SAF-LvH-Hinfos (step S338). On the other hand, in a case where the branch destination 2b is selected in step S334, the UI display/operation performance control unit 120 selects one help information from CAF-LvH-Hinfos (step S340).

In a case where the branch destination 1b is selected in above-mentioned step S332, the UI display/operation performance control unit 120 further performs random branch processing that randomly selects one branch destination from the branch destinations 3a and 3b (step S336). Subsequently, in a case where the branch destination 3a is selected in step S336, the UI display/operation performance control unit 120 selects one help information from DMF-LvH-Hinfos (step S342). On the other hand. In a case where the branch destination 3b is selected in step S336, the UI display/operation performance control unit 120 selects one help information from MF-LvH-Hinfos (step S344).

By performing the above-mentioned A-high/M-high region processing, help information based on the proficiency level is selected from four of SAF-LvH-Hinfos, CAF-LvH-Hinfos, DMF-LvH-Hinfos and MF-LvH-Hinfos with a probability of 25%.

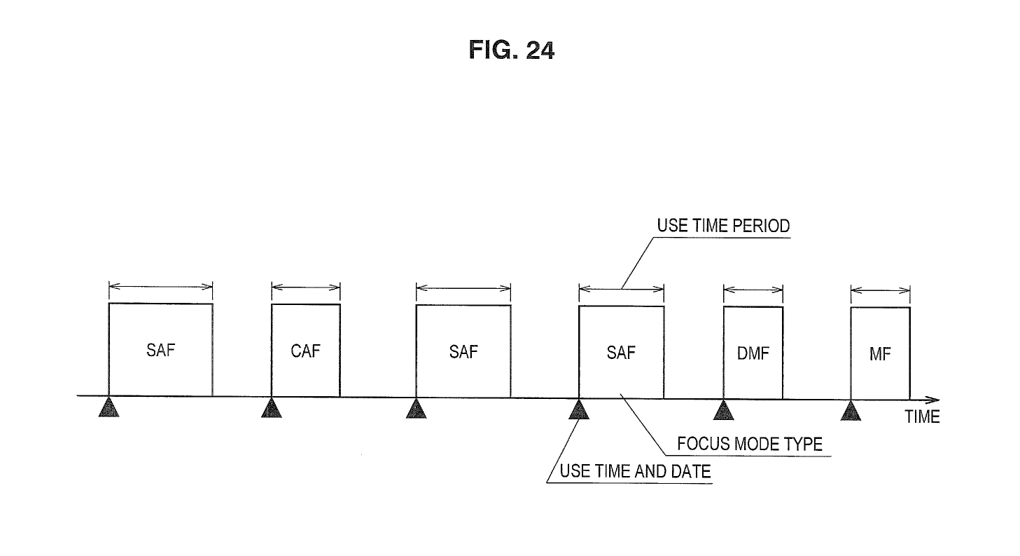

The operation history information unit 136 illustrated in FIG. 1 stores focus function history information when the focus function is used, as operation history information. Here, as illustrated in FIG. 24, it is assumed that a plurality of modes of the focus function is used in the previous predetermined time period.

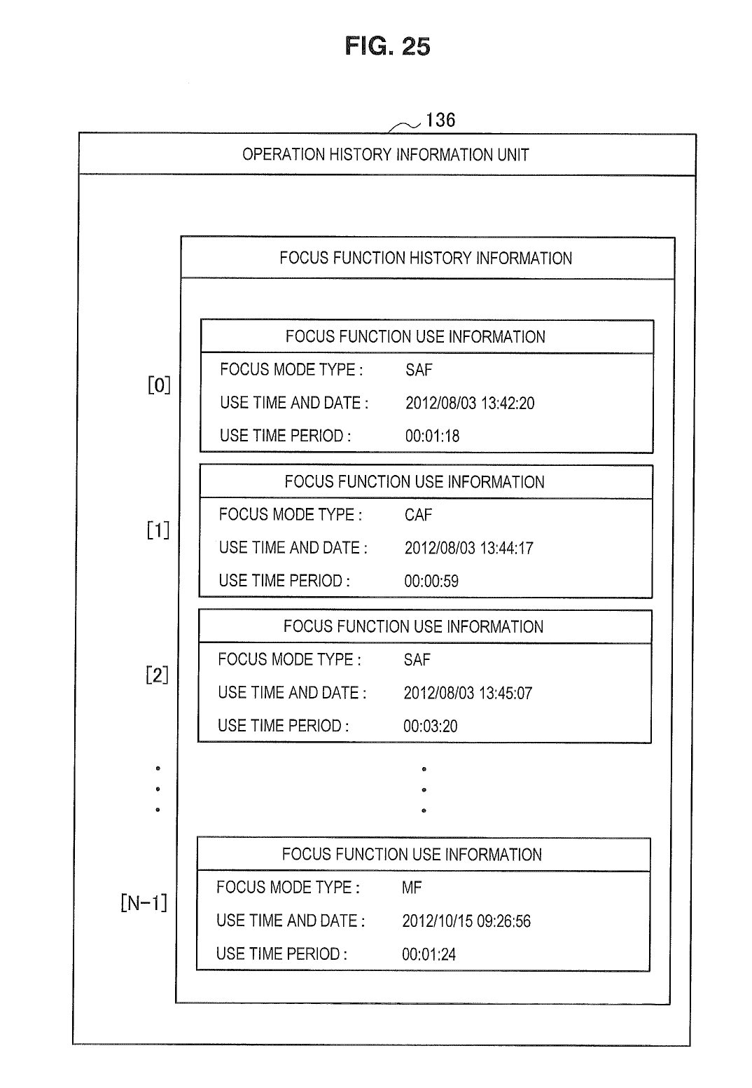

FIG. 24 is a diagram illustrating one example of the use history of the four modes of the focus function. In FIG. 24, the focus function is used in order from the SAF mode, the CAF mode, the SAF mode, the SAF mode, the DMF mode to the MF mode. In such a case, as illustrated in FIG. 25, the operation history information unit 136 extracts and stores previous N items of focus function use information.

FIG. 25 is a diagram to describe history information of the focus function. The history information of the focus function includes previous N items of focus function use information corresponding to FIG. 24. The N items of focus function use information each include information about the focus mode type, the use time and date (the use start time and date as illustrated in FIG. 24) and a use time period.

The UI display/operation performance evaluation learning unit 150 illustrated in FIG. 1 has a function to evaluate the focus function proficiency level parameter 141 of the customization parameter unit 138 on the basis of focus function history information (FIG. 25) and reconfigure the focus function proficiency level parameter 141. Therefore, the customization parameter unit 138 is assumed to store the updated focus function proficiency level parameter 141.

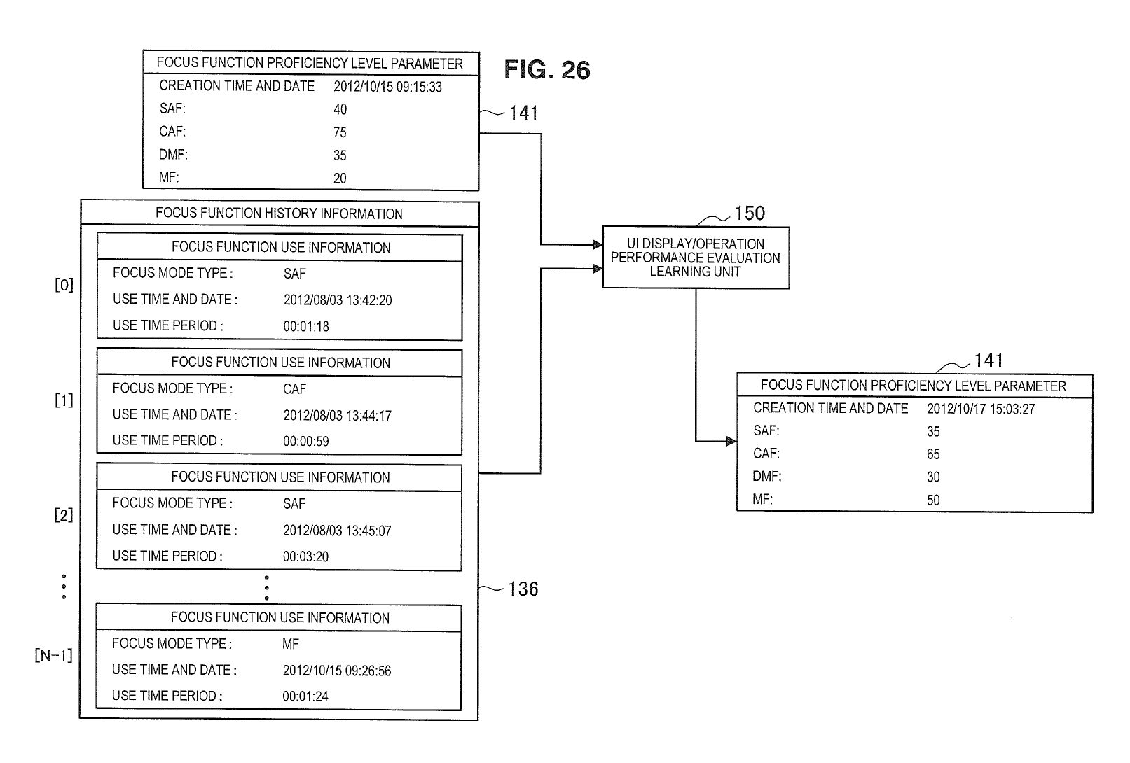

FIG. 26 is a diagram to describe the flow of evaluation processing of the focus function proficiency level parameter 141. As illustrated in FIG. 26, the UI display/operation performance evaluation learning unit 150 performs evaluation by combining the focus function proficiency level parameter 141 evaluated last time and the previous N items of focus function use information, and changes the numerical values of the proficiency levels of the four modes (SAF, CAF, DMF and MF) of the focus function. That is, the focus function proficiency level parameter 141 reflecting the previous focus function use history is generated.

At the time of evaluation, the UI display/operation performance evaluation learning unit 150 weights the focus function proficiency level parameter 141 evaluated last time and the previous N items of focus function use information. Moreover, the UI display/operation performance evaluation learning unit 150 considers the time lapse from the time of creation of the focus function proficiency level parameter 141 to the reevaluation time, and the time lapse from N focus function use times and dates to the reevaluation time. This is because the proficiency level decreases over time and therefore this viewpoint is reflected.

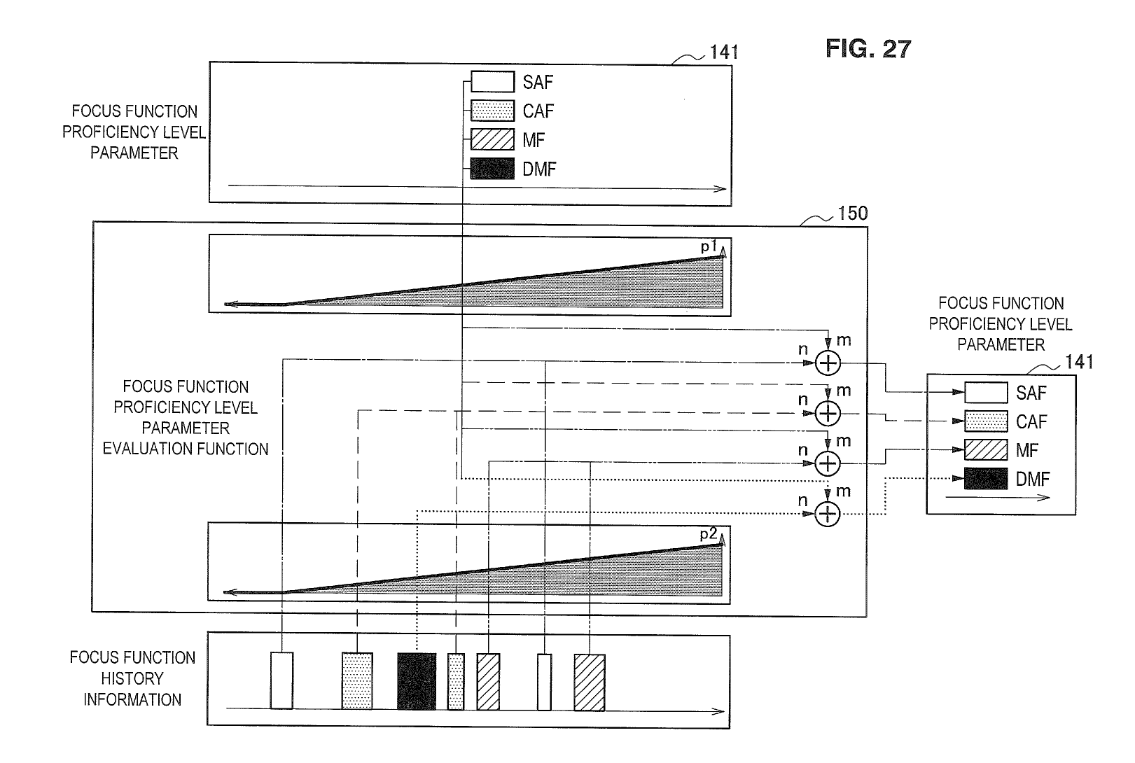

FIG. 27 is a diagram to describe weighting coefficients and time lapse coefficients at the time of evaluating the focus function proficiency level parameter 141. At the time of combining the focus function proficiency level parameter 141 evaluated last time and the previous N items of focus function use information, the UI display/operation performance evaluation learning unit 150 multiplies the numerical value of the proficiency level of the focus function proficiency level parameter 141 evaluated last time by a weighting coefficient m and time lapse coefficient p1. Moreover, the UI display/operation performance evaluation learning unit 150 multiplies the use time period of the previous N items of focus function use information by a weighting coefficient n and time lapse coefficient p2. Time lapse coefficients p1 and p2 take a smaller value as time passes.

(Evaluation Processing of Focus Function Proficiency Level Parameter)

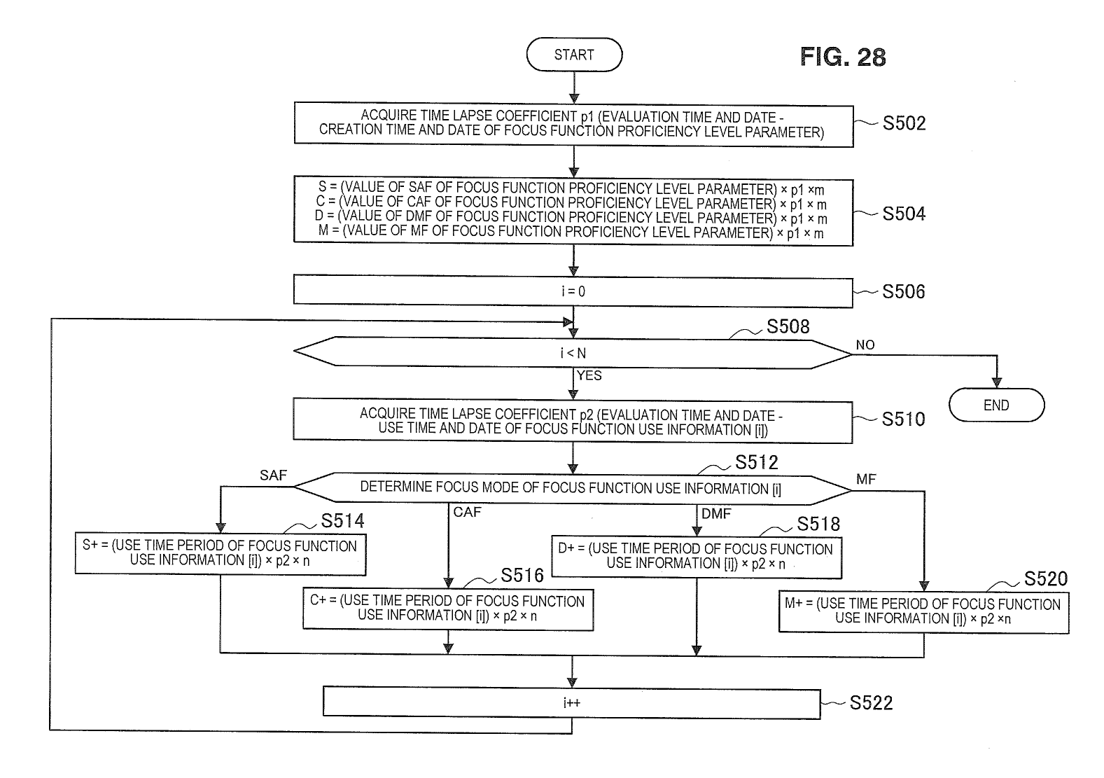

Here, specific evaluation processing of the focus function proficiency level parameter 141 is described with reference to FIG. 28. FIG. 28 is a flowchart to describe one example of evaluation processing of the focus function proficiency level parameter 141. The evaluation processing illustrated in FIG. 28 is performed, for example, when a focus mode is changed.

First, in the flowchart of FIG. 28, first, the UI display/operation performance evaluation learning unit 150 calculates time lapse coefficient p1 (step S502). Time lapse coefficient p1 becomes a value based on the elapsed time from the creation time and date of the previous focus function proficiency level parameter to the current evaluation time.

Next, the UI display/operation performance evaluation learning unit 150 calculates evaluation values S, C, D and M of the proficiency levels of SAF, CAF, DMF and MF reflecting weighting coefficient m and time lapse coefficient p1, like following equations (step S504).

S=(numerical value of proficiency level of SAF of focus function proficiency level parameter)×p1×m

C=(numerical value of proficiency level of CAF of focus function proficiency level parameter)×p1×m

D=(numerical value of proficiency level of DMF of focus function proficiency level parameter)×p1m

M=(numerical value of proficiency level of MF of focus function proficiency level parameter)×p1×m

Next, the UI display/operation performance evaluation learning unit 150 sets “i” (where “i” is an integer equal to or greater than 0) to 0 (step S506). Next, the UI display/operation performance evaluation learning unit 150 determines whether “i” is less than focus function use information number N recorded in focus function history information (step S508).

In a case where “i” is less than N in step S508 (Yes), the UI display/operation performance evaluation learning unit 150 calculates time lapse coefficient p2 (step S510). Time lapse coefficient p2 becomes a value based on the elapsed time from the use time and date of focus function use information [i] to the current evaluation time.

Next, the UI display/operation performance evaluation learning unit 150 determines the focus mode type of focus function use information [i] in history information of the focus function (step S512). Subsequently, in a case where it is determined that the mode type is SAF in step S512, the UI display/operation performance evaluation learning unit 150 calculates evaluation value S of the proficiency level of SAF reflecting time lapse coefficient p2 again, like an equation listed below (step S514).

S+=(use time period of focus function use information[i])×p2×n

Here, “n” in the above-mentioned equation denotes a weight coefficient with respect to focus function history information and is set in advance.

In a case where it is determined that the mode type is CAF in step S512, the UI display/operation performance evaluation learning unit 150 calculates evaluation value S of the proficiency level of CAF again, like an equation listed below (step S516).

C+=(use time period of focus function use information[i])×p2×n

In a case where it is determined that the mode type is DMF in step S512, the UI display/operation performance evaluation learning unit 150 calculates evaluation value D of the proficiency level of DMF again, like an equation listed below (step S516).

D+=(use time period of focus function use information[i])×p2×n

In a case where it is determined that the mode type is MF in step S512, the UI display/operation performance evaluation learning unit 150 calculates evaluation value M of the proficiency level of MF again, like an equation listed below (step S516).

M+=(use time period of focus function use information[i])×p2×n

Subsequently, when any of evaluation value S, C, D and M is calculated, the UI display/operation performance evaluation learning unit 150 increments “i” only by 1 (step S522) and repeats the processing in step S508 and subsequent steps.

On the other hand, in a case where “i” is not less than N in step S508 (No), the processing ends. As a result of this, the focus function proficiency level parameter 141 in which the numerical values of the proficiency levels of SAF, CAF, DMF and MF are reconfigured is calculated.

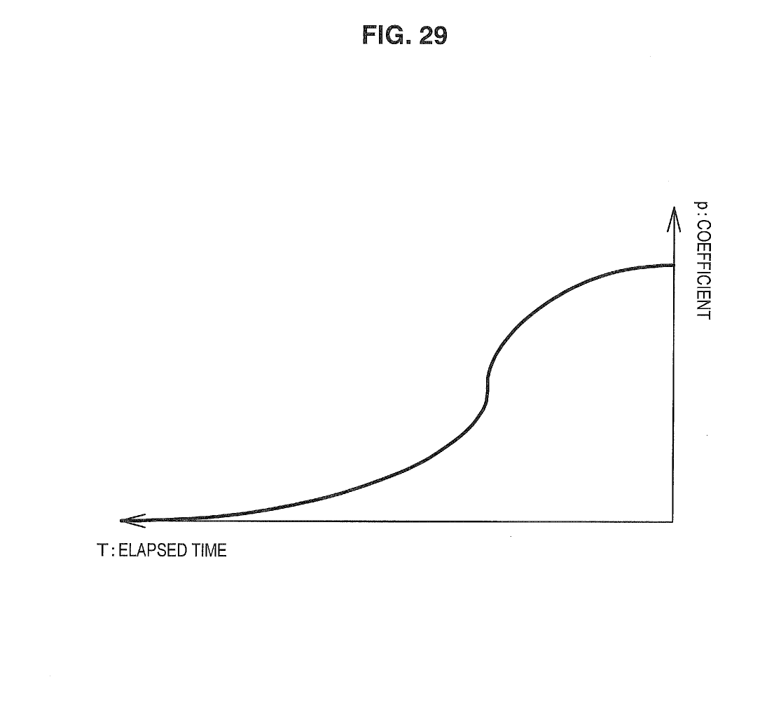

Here, although the relationship between the above-mentioned time lapse coefficient and the time is the straight line relationship as illustrated in FIG. 27, it is not limited to this, and, for example, it may be the curb line relationship as illustrated in FIG. 29. FIG. 29 is a schematic diagram to describe a variation example of the time lapse coefficient.

(4-2. Automatic Adjustment of Proficiency Level of Operation Response of Focus Ring)

For example, a focus ring is installed in a digital camera that is the information processing apparatus 100 such that the user can adjust the focus by hand power.

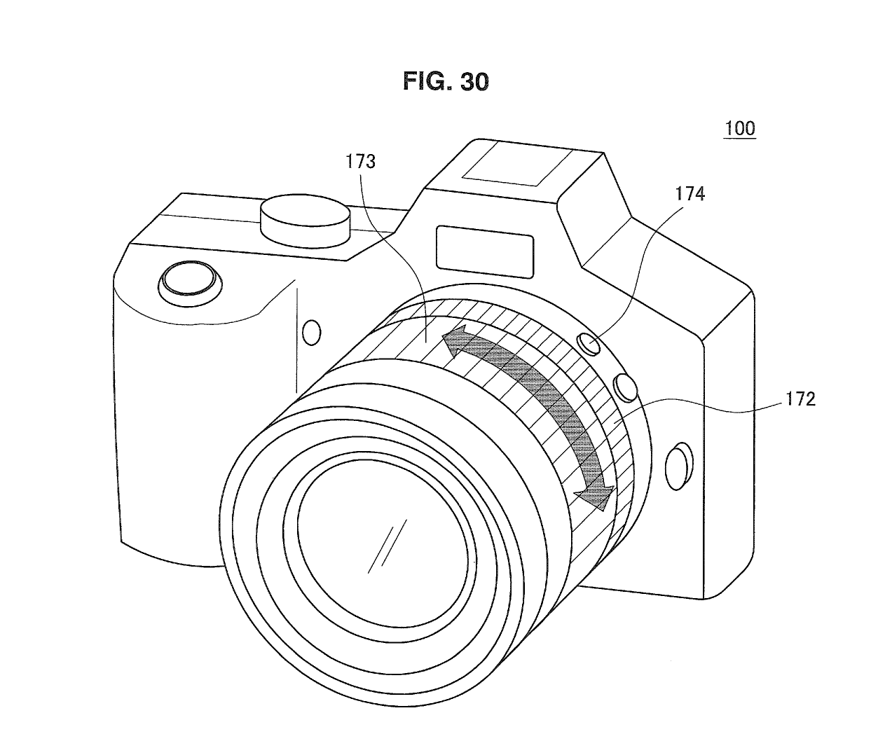

FIG. 30 is a perspective view illustrating one example of an appearance configuration of the information processing apparatus 100. As illustrated in FIG. 30, a rotatable focus ring 172 is installed in the information processing apparatus 100. The user can adjust the degree of focus by rotating the focus ring 172. Here, as illustrated in FIG. 30, a zoom ring 173 by which the user can manually adjust the zoom magnification and a focus mode switch 174 by which the user can select a focus mode, are installed in the information processing apparatus 100.

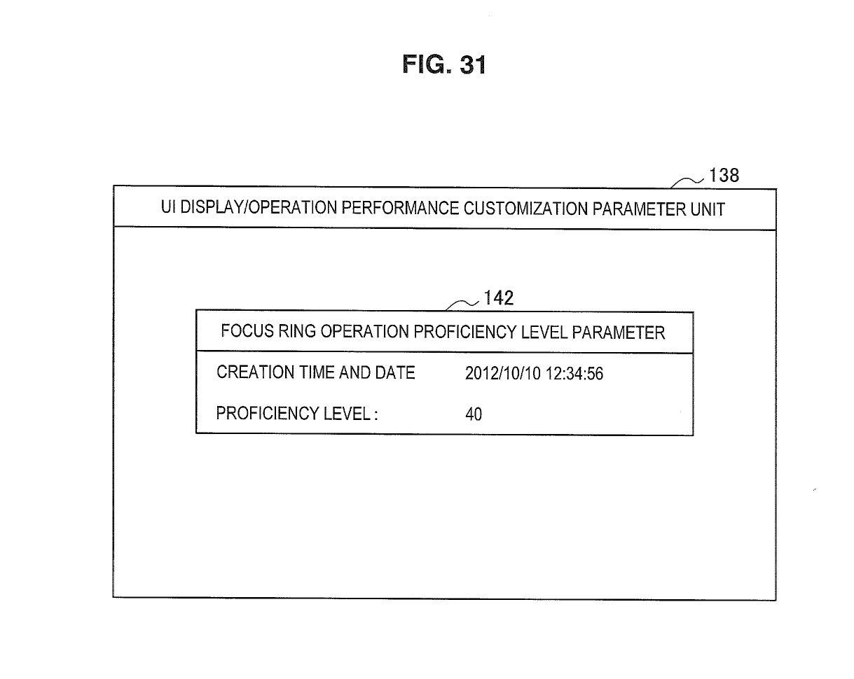

By the way, in the present embodiment, when the focus is adjusted by the focus ring 172, a response to user's operation of the focus ring 172 is changed according to the user's proficiency level. Subsequently, when the response to the operation of the focus ring 172 is changed, the focus ring operation proficiency level parameter 142 illustrated in FIG. 31 is used.

FIG. 31 is a diagram to describe the focus ring operation proficiency level parameter 142. As illustrated in FIG. 31, the focus ring operation proficiency level parameter 142 includes information about the parameter creation time and date and the proficiency level value. The proficiency level value becomes larger as the operation number of the focus ring increases.

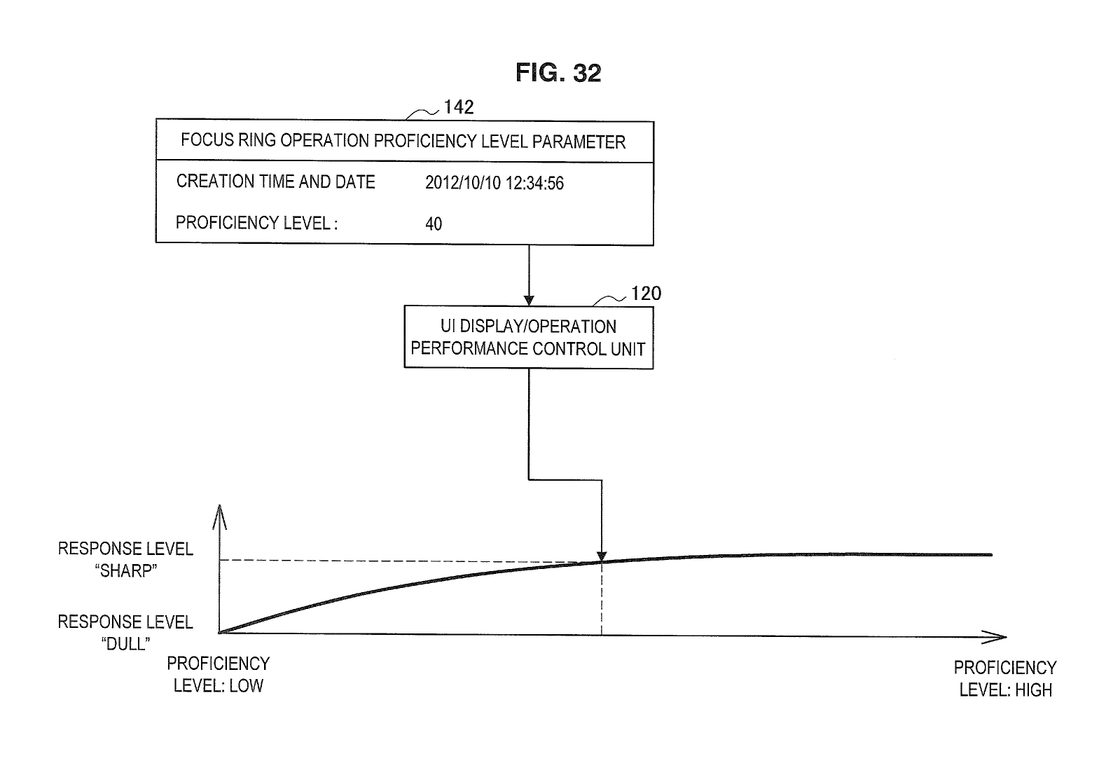

The UI display/operation performance control unit 120 illustrated in FIG. 1 changes an operation response of the focus ring according to the proficiency level of the focus ring operation. To be more specific, as illustrated in FIG. 32, the UI display/operation performance control unit 120 changes the operation response on the basis of the focus ring operation proficiency level parameter 142.

FIG. 32 is a diagram illustrating an example of the operation response change based on the proficiency level of the focus ring operation. As illustrated in FIG. 32, the UI display/operation performance control unit 120 sharpens the operation response of the focus ring 172 when the proficiency is larger, and dulls the operation response when the proficiency level is smaller. To be more specific, as the proficiency level is larger, the UI display/operation performance control unit 120 increases the focus adjustment amount with respect to a predetermined rotation amount of the focus ring 172.

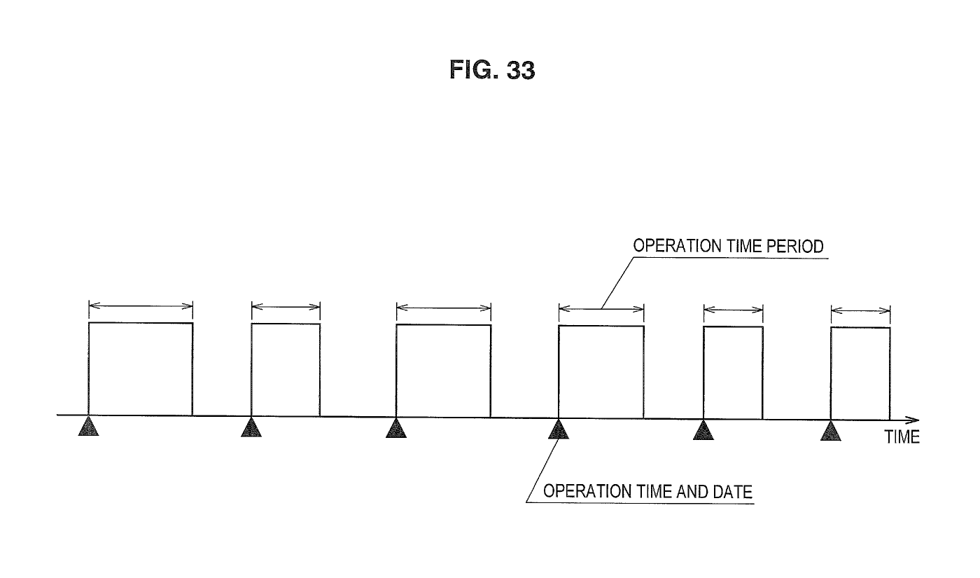

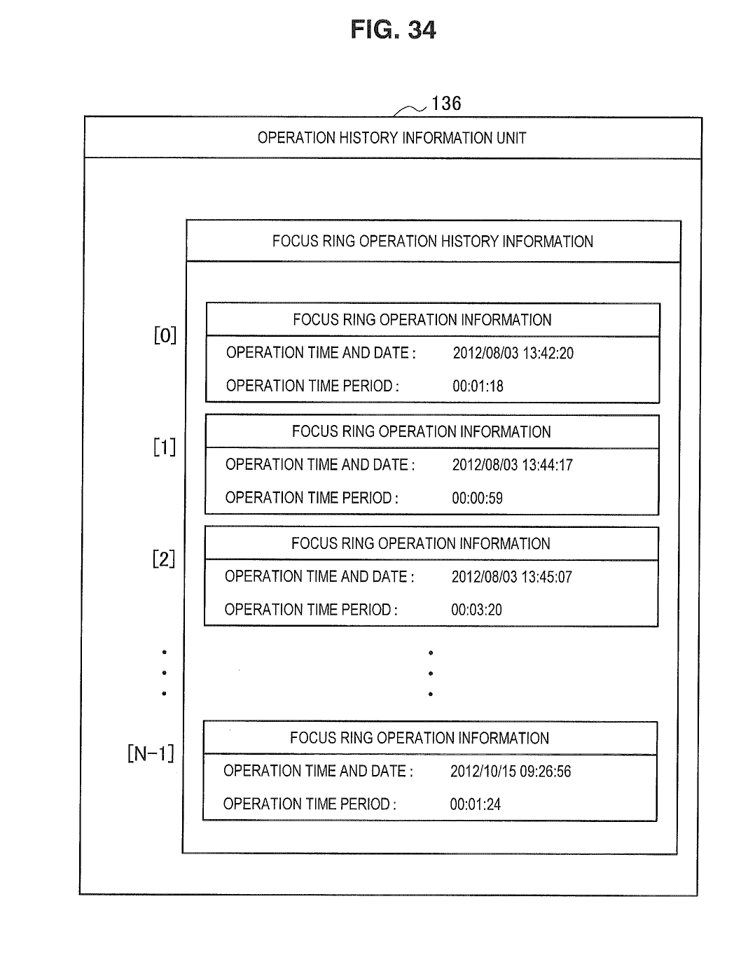

FIG. 33 is a diagram illustrating one example of the operation history of the focus ring 172. In FIG. 33, the focus ring 172 is operated multiple times. In such a case, as illustrated in FIG. 34, the operation history information unit 136 extracts and stores history information about previous N focus ring operations.

FIG. 34 is a diagram to describe history information about the focus ring operation. The focus ring operation history information illustrated in FIG. 34 includes previous N items of focus ring operation information corresponding to FIG. 33. The N items of focus ring operation information each include information about the operation time and date (the operation start time and date as illustrated in FIG. 33) and the operation time.

The UI display/operation performance evaluation learning unit 150 illustrated in FIG. 1 has a function to evaluate the focus ring operation proficiency level parameter 142 of the customization parameter unit 138 on the basis of focus function history information and reconfigure the focus ring operation proficiency level parameter 142. Therefore, the updated focus ring operation proficiency level parameter 142 is assumed to be stored in the customization parameter unit 138.

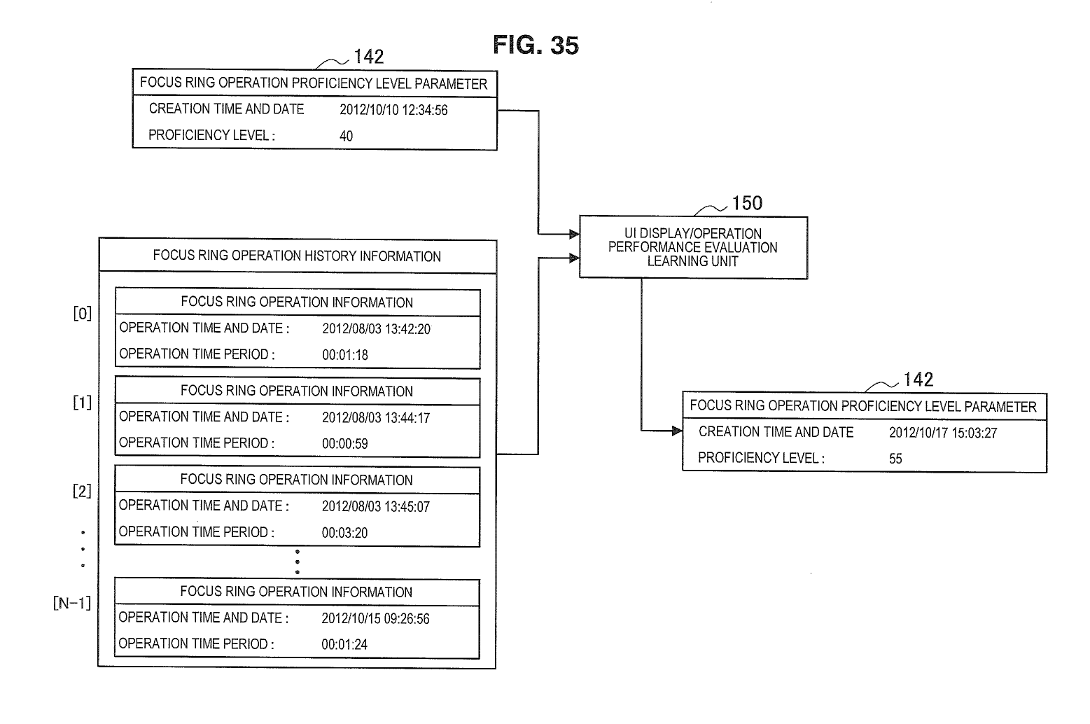

FIG. 35 is a diagram to describe the flow of evaluation processing of the focus ring operation proficiency level parameter 142. As illustrated in FIG. 35, the UI display/operation performance evaluation learning unit 150 performs evaluation by combining the focus ring operation proficiency level parameter 142 evaluated last time and the previous N items of focus ring operation information, and changes the numerical value of the proficiency level of the focus ring operation. That is, the focus ring operation proficiency level parameter 142 reflecting the previous focus ring operation history is generated.

At the time of evaluation, the UI display/operation performance evaluation learning unit 150 weights the focus ring operation proficiency level parameter 142 evaluated last time and the previous N items of focus ring operation use information. Moreover, the UI display/operation performance evaluation learning unit 150 considers the time lapse from the time of creation of the previous focus ring operation proficiency level parameter 142 to the reevaluation time, and the time lapse from N focus ring operation times and dates to the reevaluation time. This is because the proficiency level decreases over time and therefore this viewpoint is reflected.

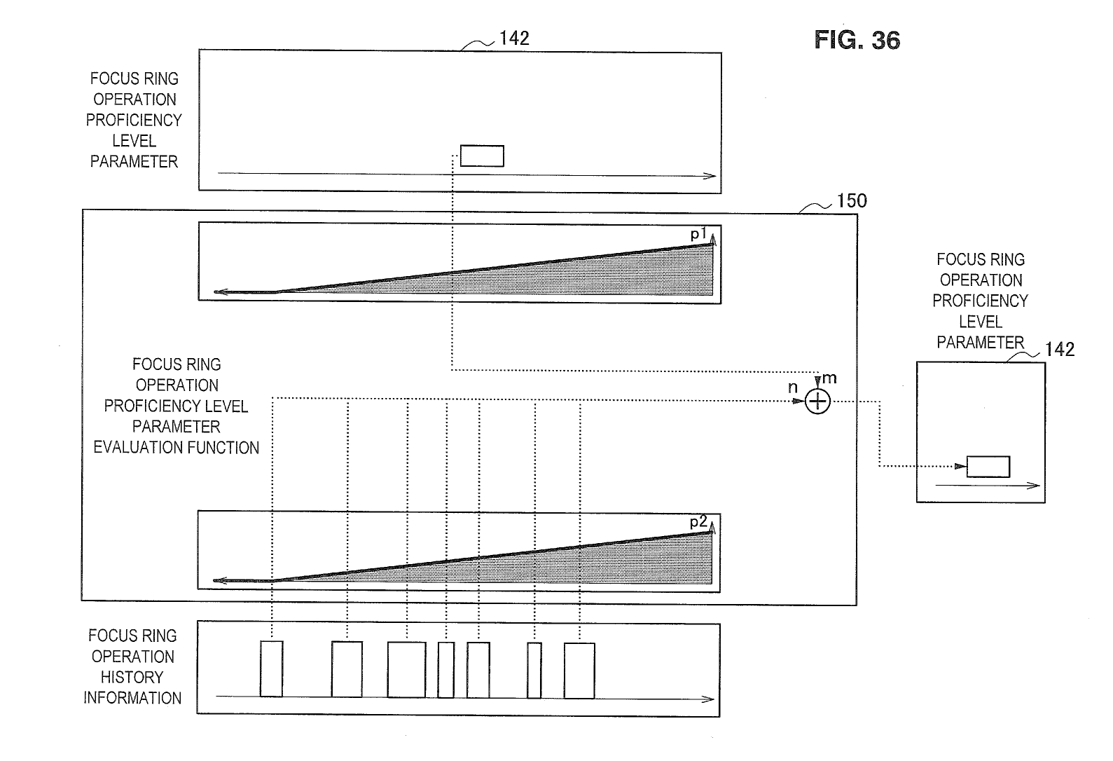

FIG. 36 is a diagram to describe weighting coefficients and time lapse coefficients at the time of evaluating the focus ring operation proficiency level parameter 142. At the time of combining the focus ring operation proficiency level parameter 142 evaluated last time and the previous N items of focus ring operation information, the UI display/operation performance evaluation learning unit 150 multiplies the numerical value of the proficiency level of the focus ring operation proficiency level parameter 142 evaluated last time by a weighting coefficient m and time lapse coefficient p1. Moreover, the UI display/operation performance evaluation learning unit 150 multiplies the use time period of the previous N items of focus ring operation information by a weighting coefficient n and time lapse coefficient p2. Time lapse coefficients p1 and p2 take a smaller value as time passes.

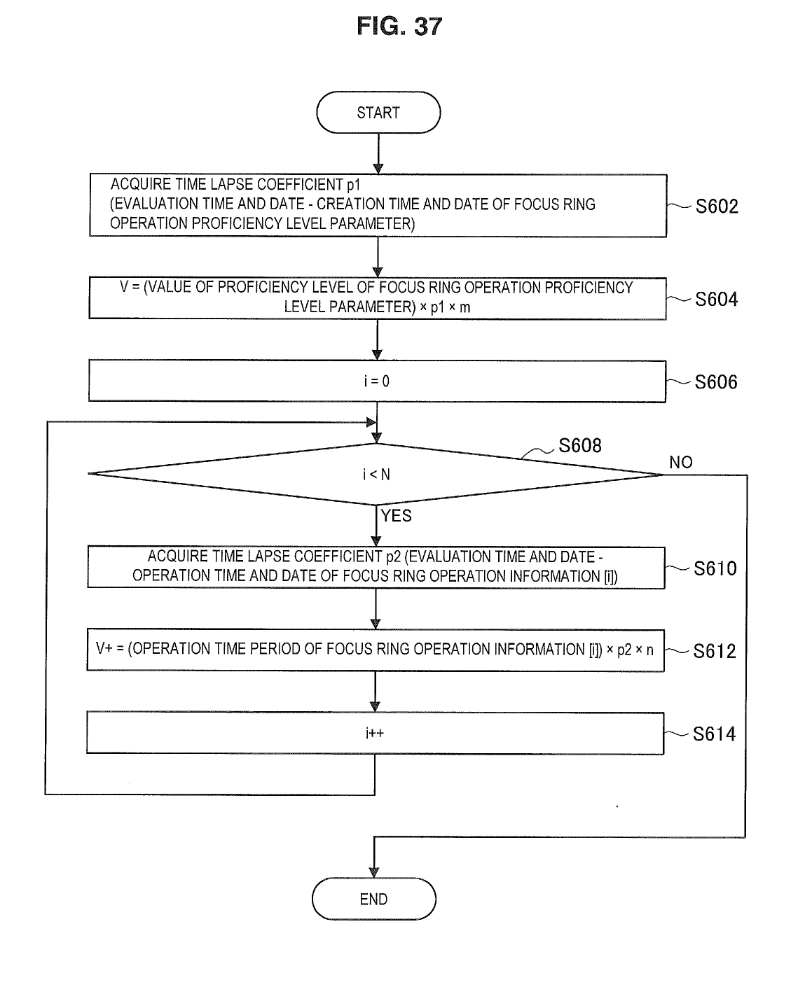

Here, specific evaluation processing of the focus ring operation proficiency level parameter 142 is described with reference to FIG. 37. FIG. 37 is a flowchart to describe one example of evaluation processing of the focus ring operation proficiency level parameter 142. The evaluation processing illustrated in FIG. 37 is performed, for example, when it is changed to the manual focus mode.

First, in the flowchart of FIG. 37, the UI display/operation performance evaluation learning unit 150 calculates time lapse coefficient p1 (step S602). Time lapse coefficient p1 becomes a value based on the elapsed time from the creation time and date of the previous focus ring operation proficiency level parameter to the current evaluation time.

Next, the UI display/operation performance evaluation learning unit 150 calculates evaluation value V of the proficiency level of the focus ring operation proficiency level parameter reflecting weighting coefficient m and time lapse coefficient p1, like an equation listed below (step S604).

V=(numerical value of proficiency level of focus ring operation proficiency level parameter)×p1×m

Next, the UI display/operation performance evaluation learning unit 150 sets “i” (where “i” is an integer equal to or greater than 0) to 0 (step S606). Next, the UI display/operation performance evaluation learning unit 150 determines whether “i” is less than focus ring operation information number N recorded in focus ring operation history information (step S608).

In a case where “i” is less than N in step S608 (Yes), the UI display/operation performance evaluation learning unit 150 calculates time lapse coefficient p2 (step S610). Time lapse coefficient p2 becomes a value based on the elapsed time from the operation time and date of focus ring operation information [i] to the current evaluation time.

Next, the UI display/operation performance evaluation learning unit 150 calculates evaluation value V reflecting weighting coefficient n and time lapse coefficient p2 again, like an equation listed below (step S612).

V+=(operation time period of focus ring operation information[i])×p2×n

Next, the UI display/operation performance evaluation learning unit 150 increments “i” only by 1 (step S614) and repeats the processing in step S608 and subsequent steps. In a case where “i” is not less than N in step S608 (No), the present processing ends. As a result of this, the focus ring operation proficiency level parameter 142 in which the numerical value of the proficiency level is recreated is calculated.

Here, although the response level of the focus ring 172 is changed according to the user's proficiency level in the above-mentioned description, it is not limited to this. For example, the same applies to the change in the response level of the zoom ring 173 illustrated in FIG. 30.

(4-3. Simplification of Operation Step According to Proficiency Level of Recording Mode Setting)

The information processing apparatus 100 can record a captured video. Subsequently, it is designed such that the user can set a video recording mode in the UI display unit 110.

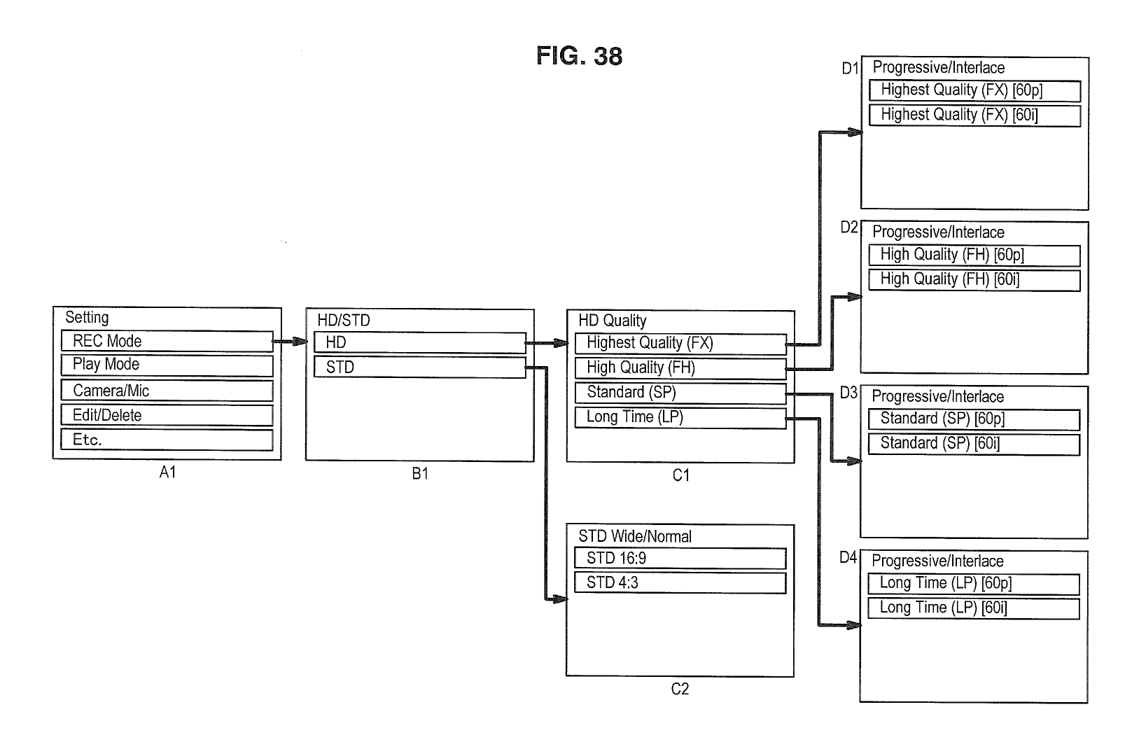

FIG. 38 is a diagram to describe the flow of normal setting operation of the recording mode. When the user selects the recording mode (REC mode) in selection screen A1, it shifts to selection screen B1. In selection screen B1, the user can select either of an HD recording mode with hi-vision image quality or an STD recording mode with standard image quality. The picture size is different between the HD recording mode and the STD recording mode, for example, the picture size of the HD recording mode is 1920×1080 pixels and the picture size of the STD recording mode is 720×480 pixels.

When the user selects the HD recording mode in selection screen B1, it shifts to selection screen C1. In selection screen C1, the user can select either of four record qualities (bit rates) in HD. The four record qualities are, for example, Highest Quality (FX) with the highest image quality, High Quality (FH) with high image quality, Standard (SP) with standard image quality and Long Time (LP) with image quality for long-time recording. When the user selects any of the four recording qualities in selection screen C1, it shifts to one of corresponding selection screens D1 to D4. For example, when the user selects FX, it shifts to selection screen D1. In selection screens D1 to D4, the user selects progressive (60p) or interlace (60i) as a scanning system.

On the other hand, when the user selects the STD recording mode in selection screen B1, it shifts to selection screen C2. In selection screen C2, the user can select either of wide “16:9” or standard “4:3” as a screen aspect ratio. Thus, in the normal setting operation of the recording mode, it is designed to shift a plurality of selection screens and set a desired mode.

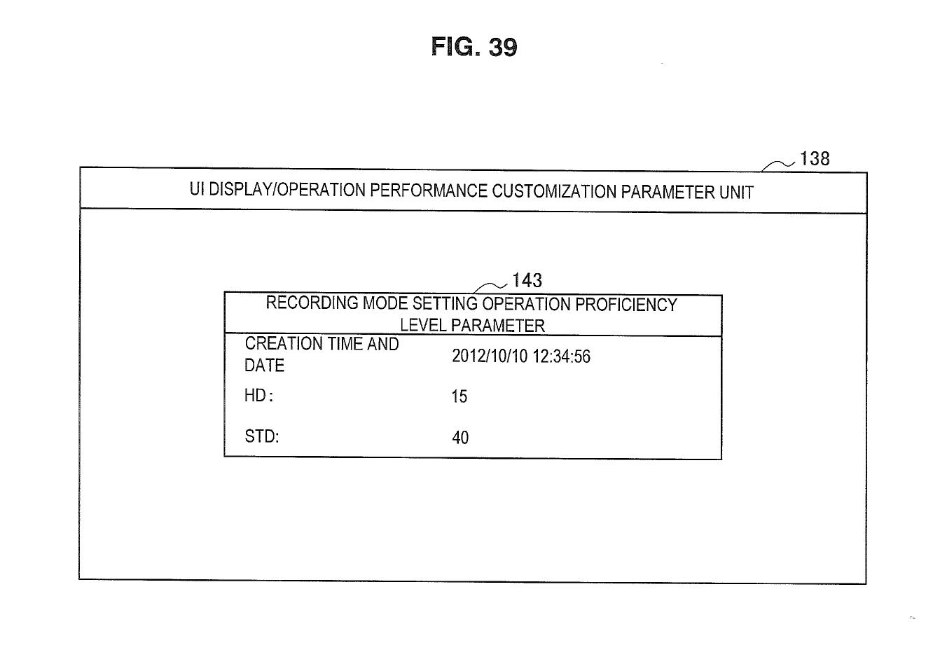

By the way, in the present embodiment, the transition patterns of the multiple selection screens to set the recording modes are automatically switched according to the proficiency level of the setting of the user's storage mode. When the transition patterns of the selection screens are switched, the recording mode setting operation proficiency level parameter 143 illustrated in FIG. 39 is used.

FIG. 39 is a diagram to describe the recording mode setting operation proficiency level parameter 143. As illustrated in FIG. 39, the recording mode setting operation proficiency level parameter 143 includes information about the parameter creation time and date and the proficiency level values of the HD recording mode setting operation and the STD recording mode setting operation. The proficiency level value increases as the setting number of the corresponding mode increases.

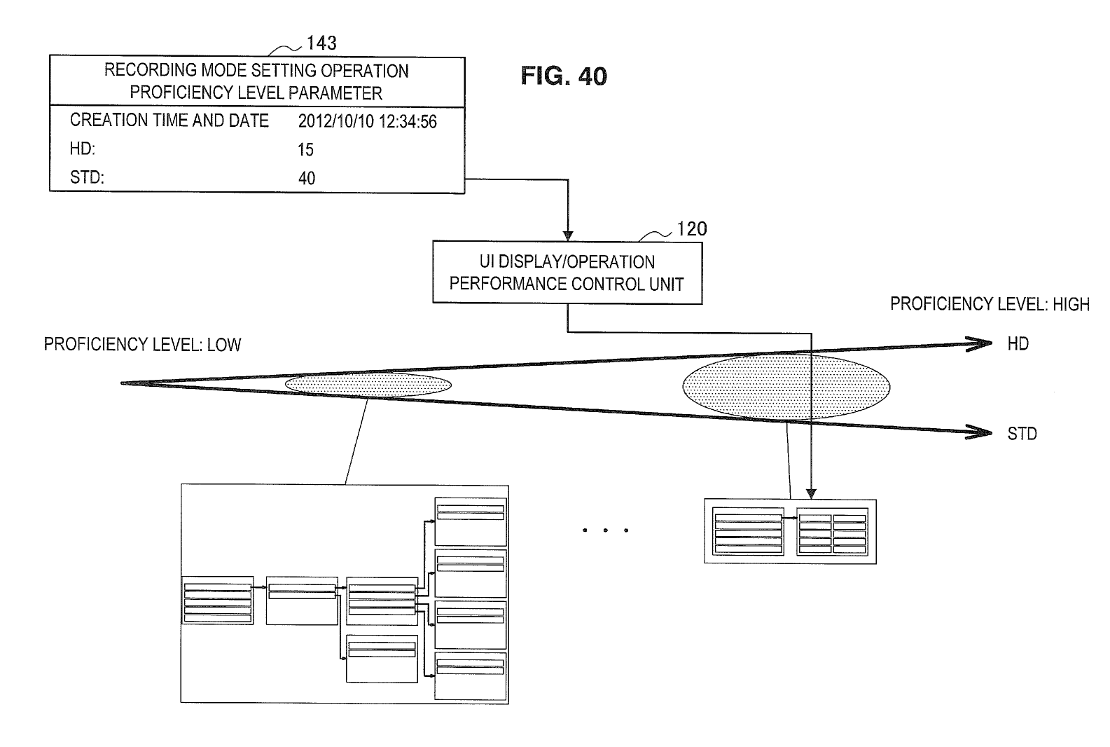

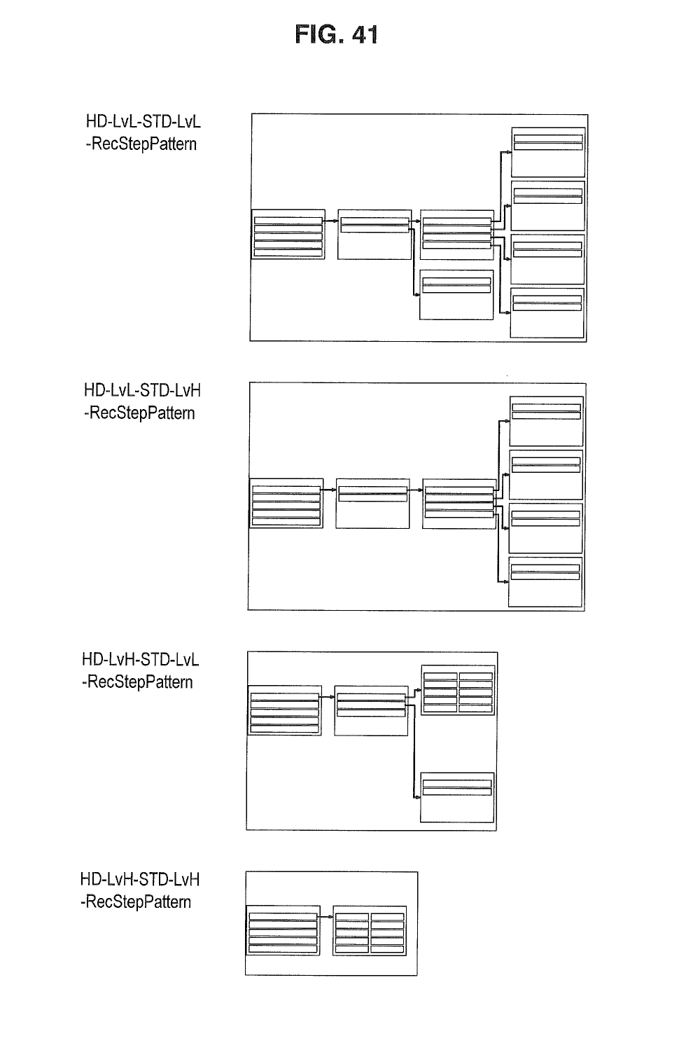

As illustrated in FIG. 40, the UI display/operation performance control unit 120 illustrated in FIG. 1 varies a transition pattern of a selection screen to be displayed, according to the proficiency levels of the HD recording mode setting operation and the STD recording mode setting operation.

FIG. 40 is a diagram illustrating the relationships between the proficiency levels of the HD recording mode setting operation and STD recording mode setting operation and transition patterns. To be more specific, the transition patterns of selection screens are simplified as the proficiency level is higher. Here, the transition pattern is set to four patterns as illustrated in FIG. 41, for example.

FIG. 41 is a diagram illustrating one example of transition patterns of selection screens based on the proficiency level. The four transition patterns illustrated in FIG. 41 are HD-LvL-STD-LvL-RecStepPattern, HD-LvL-STD-LvH-RecStepPattern, HD-LvH-STD-LvL-RecStepPattern and HD-LvH-STD-LvH-RecStepPattern. HD-LvL-STD-LvL-RecStepPattern is a transition pattern in a case where the proficiency levels of the HD recording mode setting operation and the STD recording mode setting operation are low. HD-LvL-STD-LvH-RecStepPattern is a shift pattern in a case where the proficiency level of the HD recording mode setting operation is low and the proficiency level of the STD recording mode setting operation is high. HD-LvH-STD-LvL-RecStepPattern is a transition mode in a case where the proficiency level of the HD recording mode setting operation is high and the proficiency level of the STD recording mode setting operation is low. HD-LvH-STD-LvH-RecStepPattern is a transition mode in a case where the proficiency level of the HD recording mode setting operation and the STD recording mode setting operation is high.

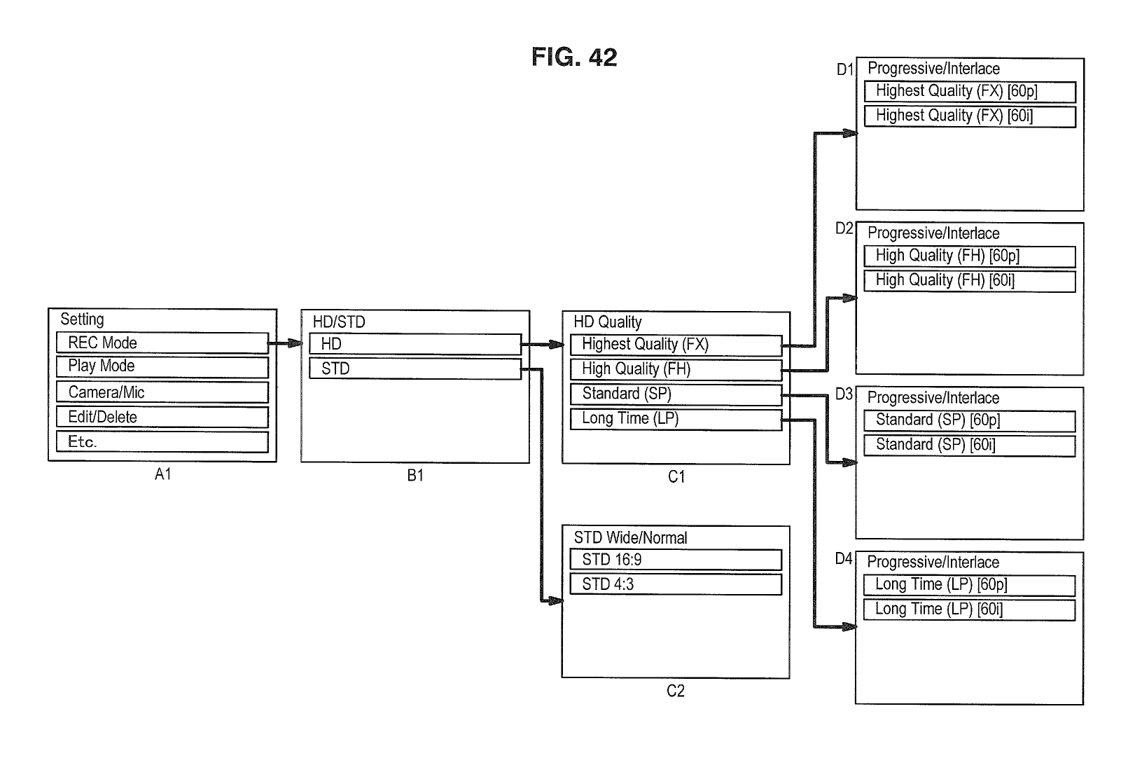

FIG. 42 is a diagram illustrating the transition of selection screens in the case of HD-LvL-STD-LvL-RecStepPattern. In this transition pattern, since the proficiency levels of the HD recording mode setting operation and the STD recording mode setting operation are low, it is the same screen transition as in the case of the normal recording mode setting operation illustrated in FIG. 38.

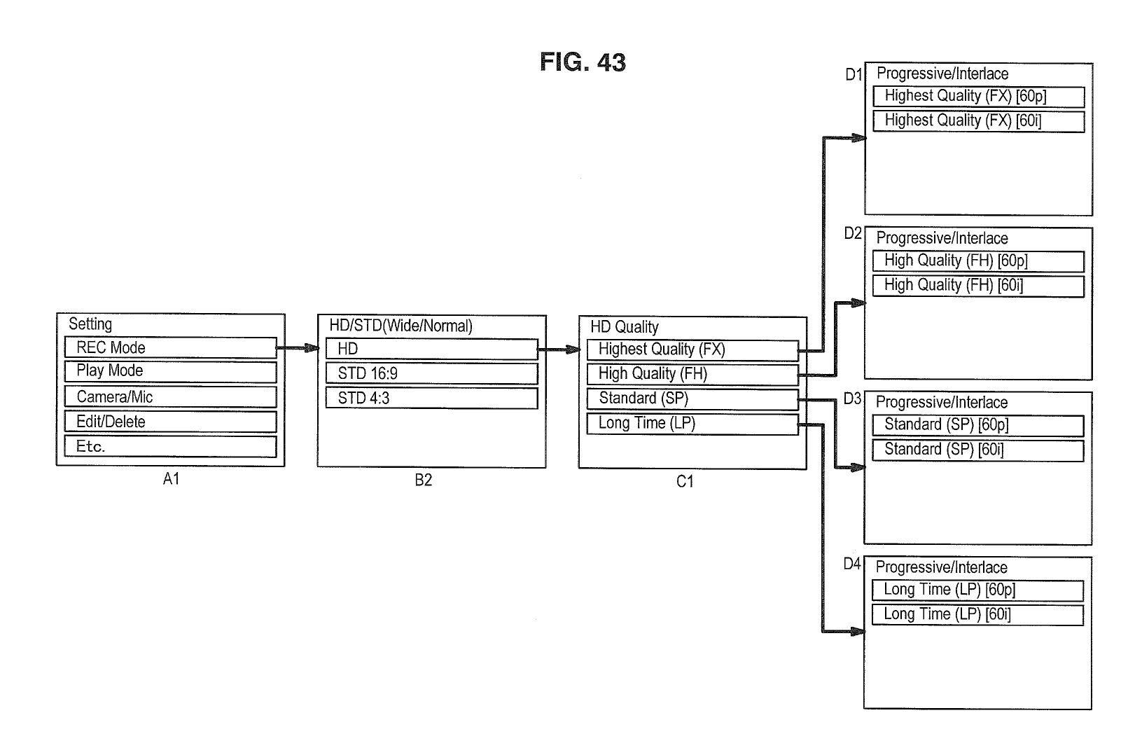

FIG. 43 is a diagram illustrating the transition of the selection screens in the case of HD-LvL-STD-LvH-RecStepPattern. In this transition pattern, since the proficiency level of the STD recording mode setting operation is high, unlike FIG. 38, it is simplified such that selection screen C2 is not provided and the screen aspect ratio is selected in selection screen B2.

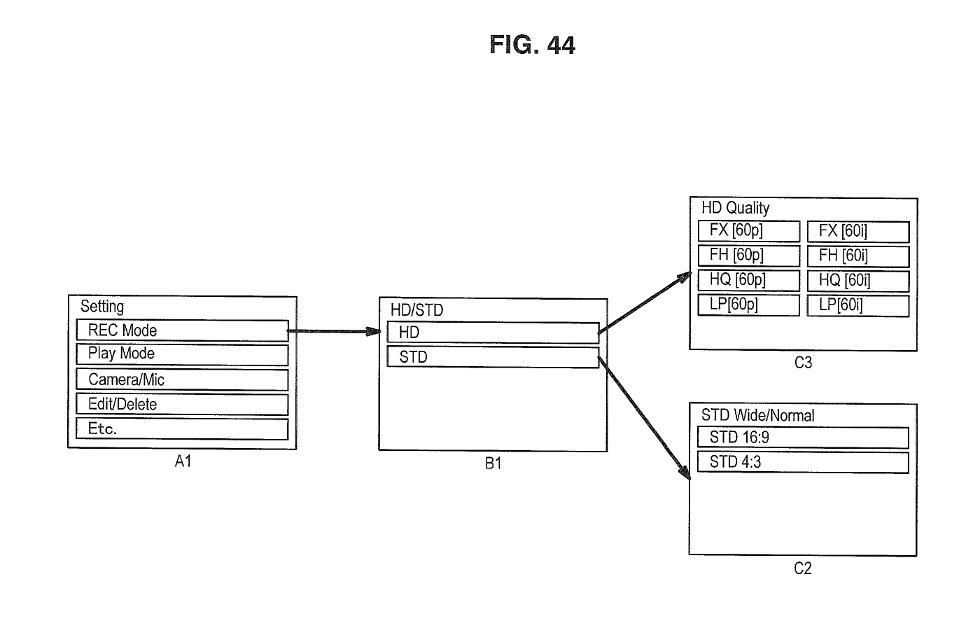

FIG. 44 is a diagram illustrating the transition of selection screens in the case of HD-LvH-STD-LvL-RecStepPattern. In this transition pattern, since the proficiency level of the HD recording mode setting operation is high, unlike FIG. 38, it is simplified such that selection screens D1 to D4 are not provided and the scanning system can be selected in selection screen C3.

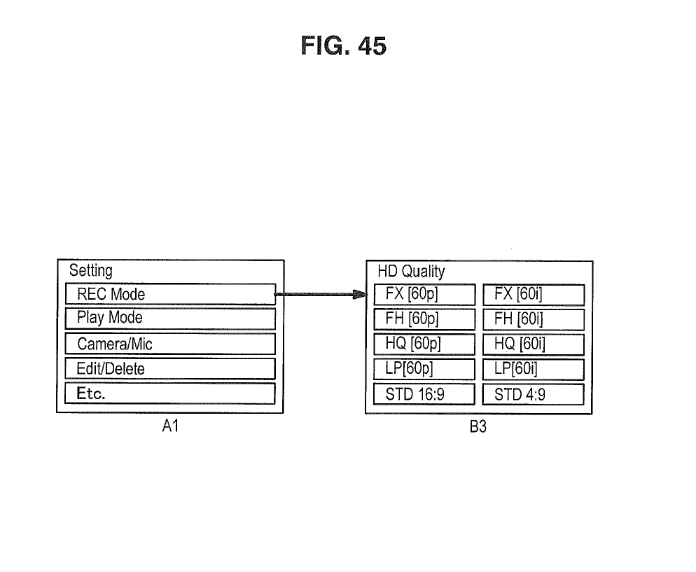

FIG. 45 is a diagram illustrating the transition of selection screens in the case of HD-LvH-STD-LvH-RecStepPattern. In this transition pattern, since the proficiency levels of the HD recording mode setting operation and the STD recording mode setting operation are high, unlike FIG. 38, it is further simplified such that selection screens C1, C2 and D1 to D4 are not provided and the scanning system for HD and the screen aspect ratio of STD can be selected in selection screen B3.

The UI display/operation performance control unit 120 automatically decides an optimal transition pattern among the four transition patterns mentioned above, according to the proficiency levels of the HD recording mode setting operation and the STD recording mode setting operation.

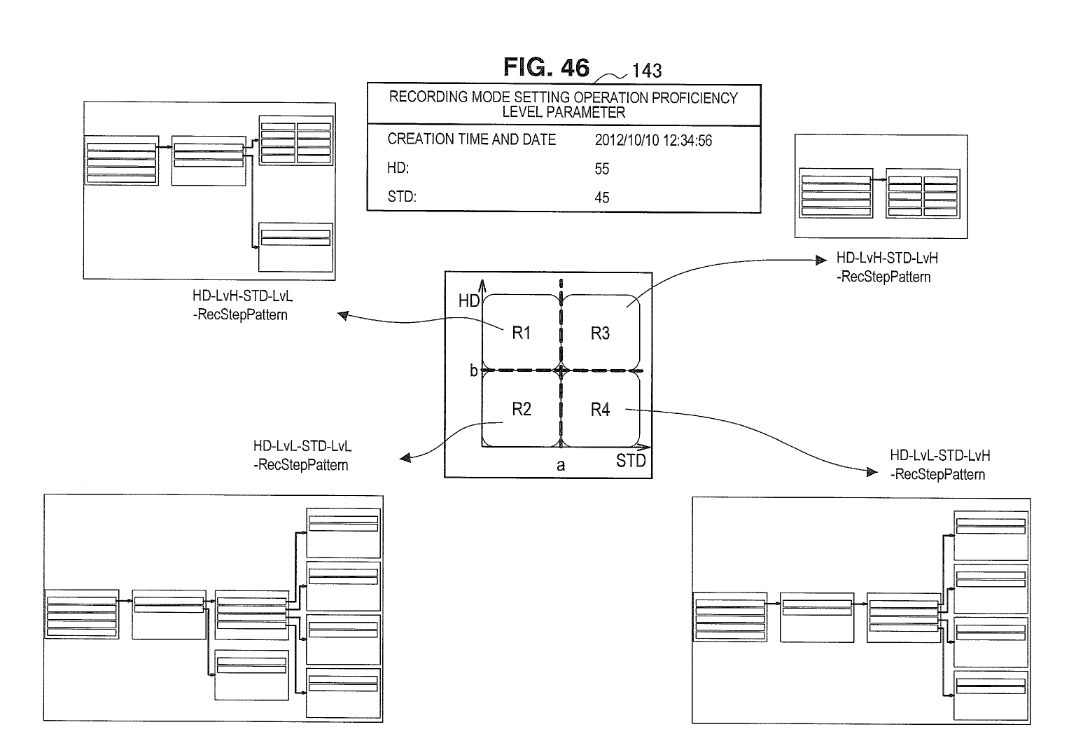

FIG. 46 is a schematic diagram to describe the flow of transition pattern decision processing in selection screens of recording modes. The UI display/operation performance control unit 120 decides a transition pattern on the basis of both values of the proficiency level of the HD recording mode setting operation and the proficiency level of the STD recording mode setting operation. For example, the UI display/operation performance control unit 120 selects HD-LvH-STD-LvL-RecStepPattern as a transition pattern in a case where proficiency level value HD of the HD recording mode setting operation is less than predetermined threshold b and proficiency level value STD of the STD recording mode setting operation is less than predetermined threshold “a” (region R3 in FIG. 46). Here, thresholds “a” and b are set in advance.

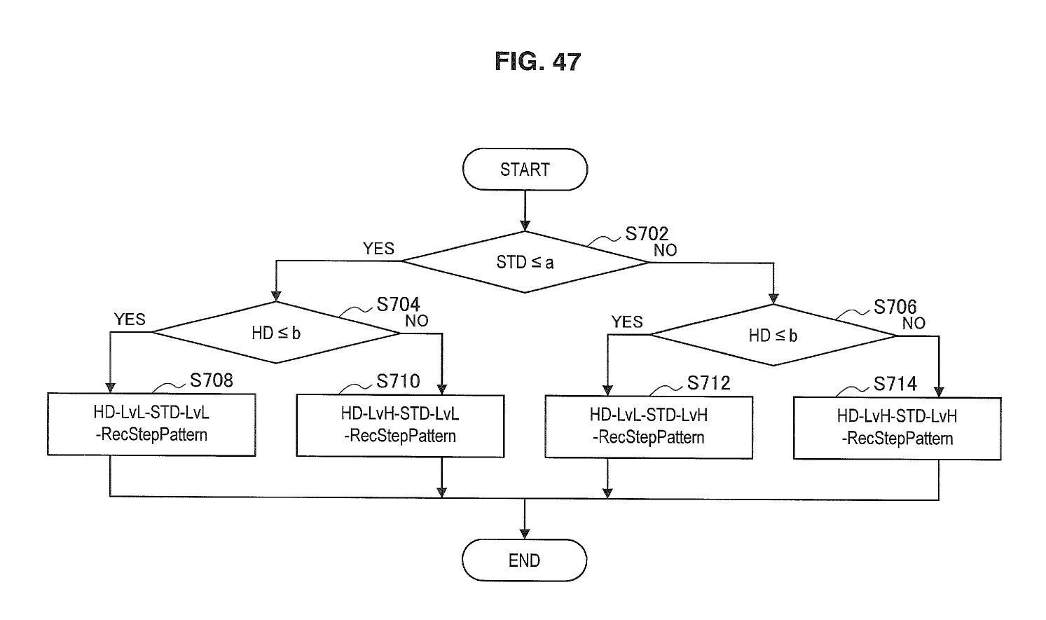

Here, specific transition pattern decision processing in the selection screens of the recording modes is described with reference to FIG. 47. FIG. 47 is a flowchart to describe one example of the transition pattern decision processing in the selection screens of the recording modes. The flowchart in FIG. 47 starts from a step in which the UI display/operation performance control unit 120 acquires proficiency level value HD of the HD recording mode setting operation and proficiency level value STD of the STD recording mode setting operation.

In the flowchart of FIG. 47, first, the UI display/operation performance control unit 120 determines whether value STD is equal to or less than predetermined threshold “a” (step S702). Subsequently, in a case where value STD is equal to or less than threshold “a” in step S702, the UI display/operation performance control unit 120 determines whether value HD is equal to or less than threshold b (step S704).

In a case where value HD is equal to or less than threshold b in step S704 (Yes), the UI display/operation performance control unit 120 selects HD-LvL-STD-LvL-RecStepPattern as a transition pattern of a recording mode selection screen (step S708). On the other hand, in a case where value HD is not equal to or less than threshold b in step S704 (No), the UI display/operation performance control unit 120 selects HD-LvH-STD-LvL-RecStepPattern (step S710).

Even in a case where value STD is not equal to or less than threshold “a” in above-mentioned step S702, the UI display/operation performance control unit 120 determines whether value HD is equal to or less than threshold b (step S706). Subsequently, in a case where value HD is equal to or less than threshold b in step S706 (Yes), the UI display/operation performance control unit 120 selects HD-LvL-STD-LvH-RecStepPattern as a transition pattern in the recording mode selection screen (step S712). On the other hand, in a case where value HD is not equal to or less than threshold b in step S706 (No), the UI display/operation performance control unit 120 selects HD-LvH-STD-LvH-RecStepPattern (step S710). As a result of this, the transition pattern decision processing is completed.

By performing the above-mentioned transition pattern decision processing in the selection screen, the transition pattern of an optimal selection screen based on the proficiency level of a recording mode selection operation is decided and the selection screen is displayed in the UI display unit 110.

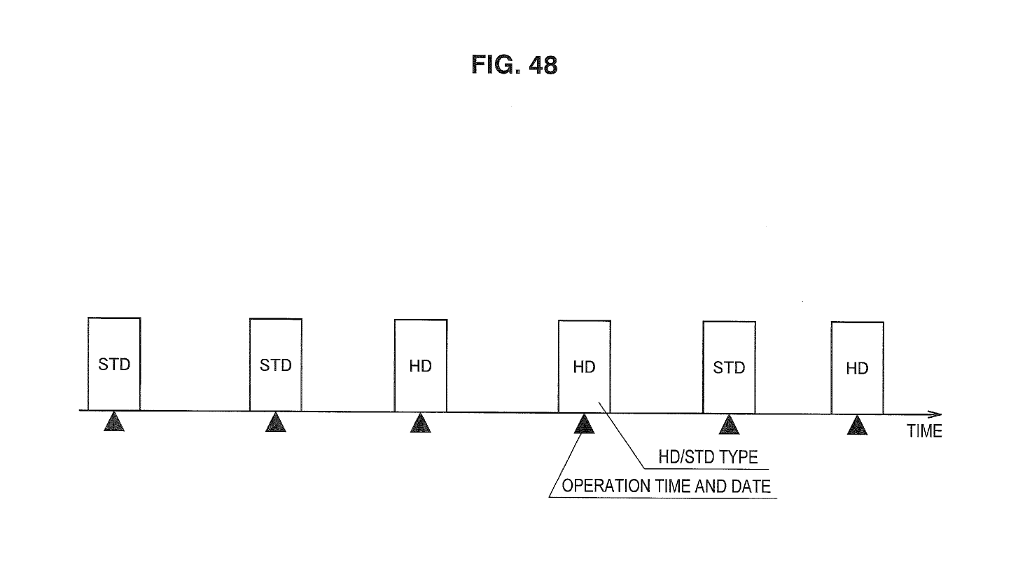

The operation history information unit 136 illustrated in FIG. 1 stores recording mode setting operation history information after a recording mode setting operation, as operation history information. Here, as illustrated in FIG. 48, it is assumed that a recording mode setting operation is performed multiple times in the previous predetermined time period.

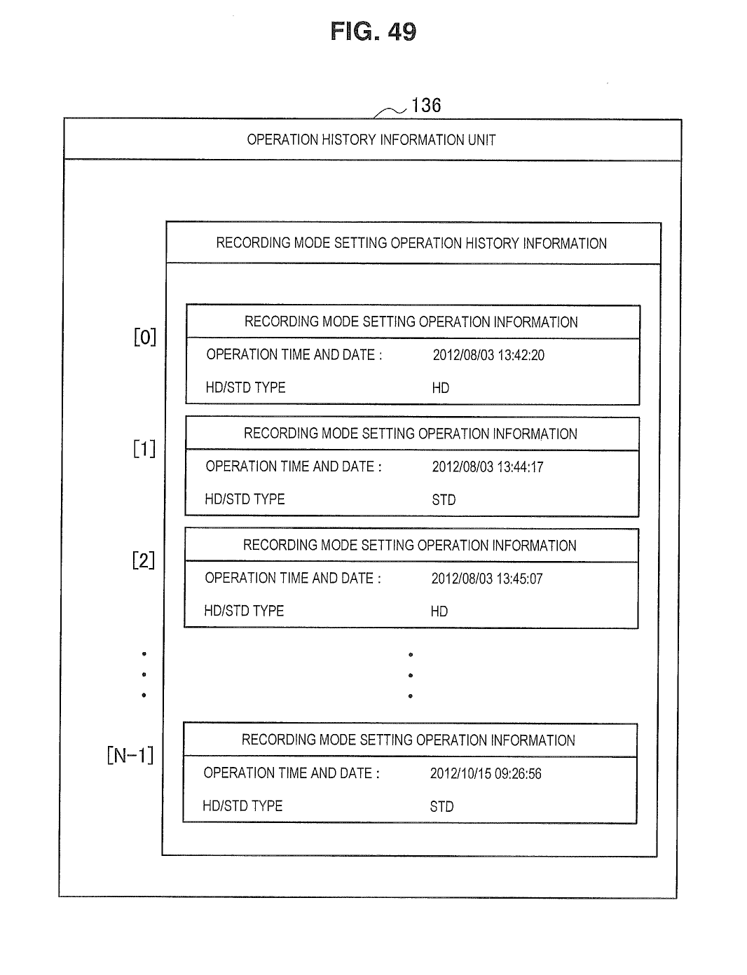

FIG. 48 is a diagram illustrating one example of the history of the recording mode setting operation. In FIG. 48, the STD recording mode, the STD recording mode, the HD recording mode, the HD recording mode, the STD recording mode and the HD recording mode are set in order. In such a case, as illustrated in FIG. 49, the operation history information unit 136 extracts and stores previous N items of recording mode setting operation information.

FIG. 49 is a diagram to describe history information of the recording mode setting operation. The history information of the recording mode setting operation includes previous N items of recording mode setting operation information corresponding to FIG. 48. The N items of recording mode setting operation information each include information about the mode setting operation time and date and the recording mode type.

The UI display/operation performance evaluation learning unit 150 illustrated in FIG. 1 has a function to evaluate the recording mode setting operation proficiency level parameter 143 of the customization parameter unit 138 on the basis of the history information of the recording mode setting operation and reconfigure the recording mode setting operation proficiency level parameter 143. Therefore, the updated recording mode setting operation proficiency level parameter 143 is assumed to be stored in the customization parameter unit 138.

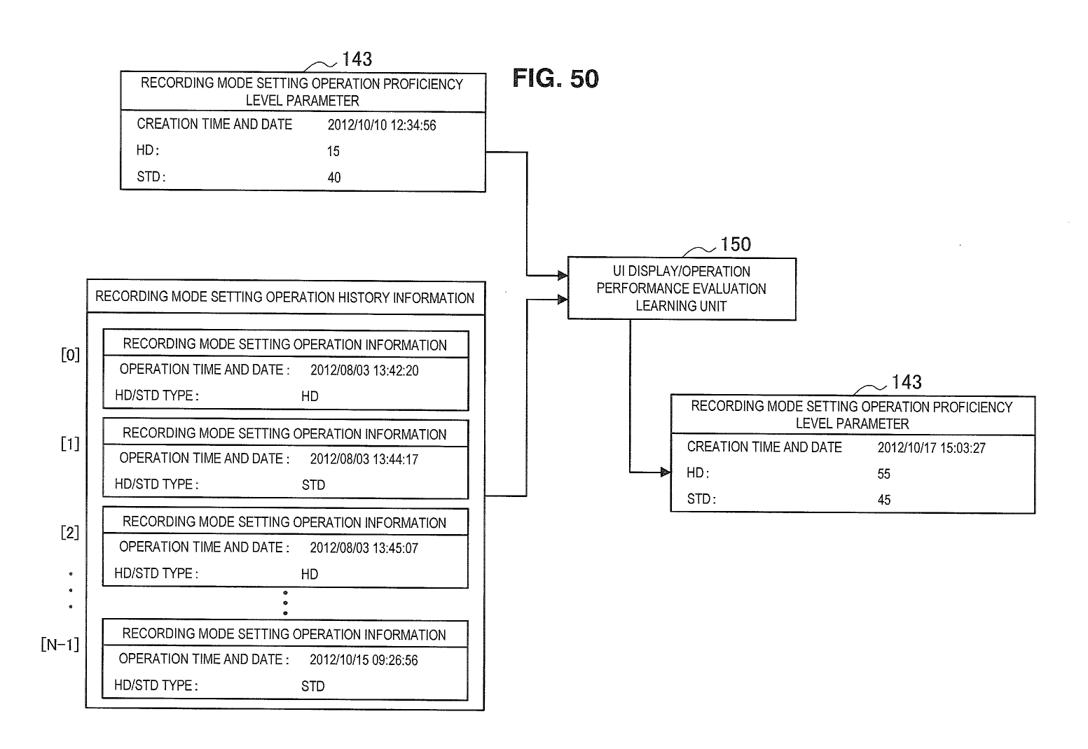

FIG. 50 is a diagram to describe the flow of evaluation processing of the recording mode setting operation proficiency level parameter 143. As illustrated in FIG. 50, the UI display/operation performance evaluation learning unit 150 performs evaluation by combining the recording mode setting operation proficiency level parameter 143 evaluated last time and the previous N items of recording mode setting operation information, and changes the numerical values of the proficiency levels of the HD recording mode setting operation and STD recording mode setting operation. That is, the recording mode setting operation proficiency level parameter 143 to which the previous recording mode setting operation is reflected is generated.

At the time of evaluation, the UI display/operation performance evaluation learning unit 150 weights the recording mode setting operation proficiency level parameter 143 evaluated last time and the previous N items of recording mode setting operation information. Moreover, the UI display/operation performance evaluation learning unit 150 considers the time lapse from the time of creation of the recording mode setting operation proficiency level parameter 143 to the reevaluation time, and the time lapse from N recording mode setting operation times and dates to the reevaluation time. This is because the proficiency level decreases over time and therefore this viewpoint is reflected.

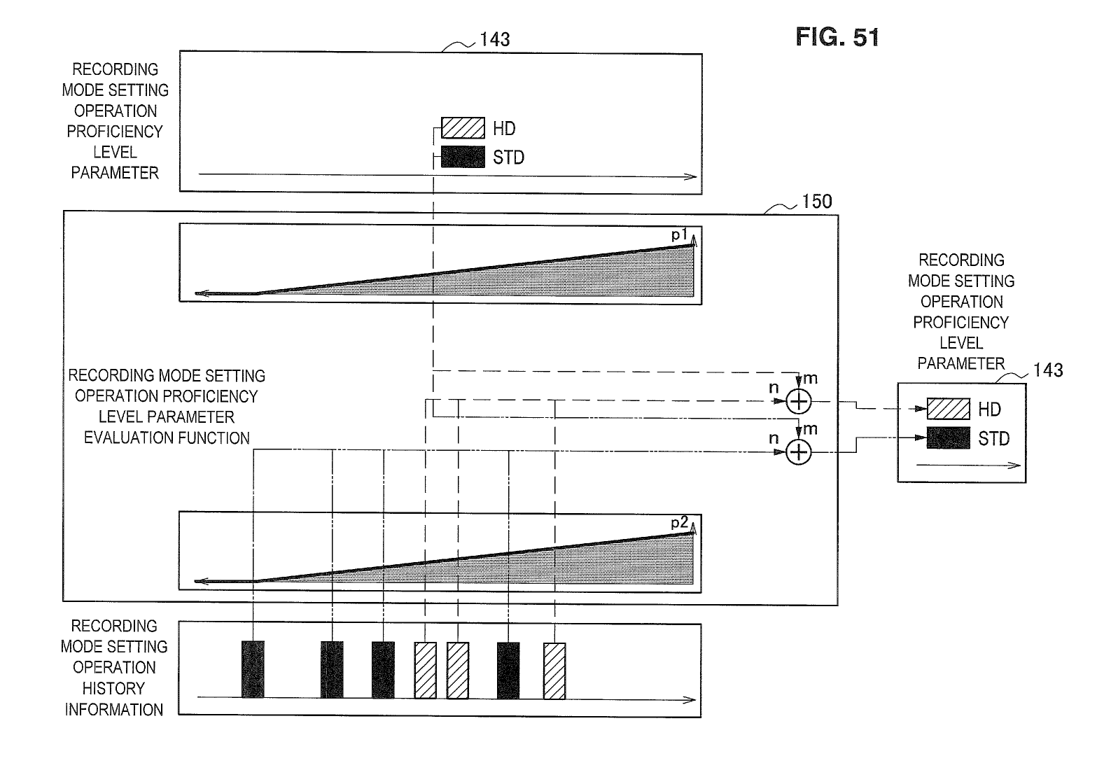

FIG. 51 is a diagram to describe weighting coefficients and time lapse coefficients at the time of evaluating the recording mode setting operation proficiency level parameter 143. At the time of combining the recording mode setting operation proficiency level parameter 143 evaluated last time and the previous N items of recording mode setting operation information, the UI display/operation performance evaluation learning unit 150 multiplies the numerical value of the proficiency level of the recording mode setting operation proficiency level parameter 143 evaluated last time by a weighting coefficient m and time lapse coefficient p1. Moreover, the UI display/operation performance evaluation learning unit 150 multiplies the operation times and dates of the previous N items of recording mode setting operation information by a weighting coefficient n and time lapse coefficient p2. Time lapse coefficients p1 and p2 take a smaller value as time passes.

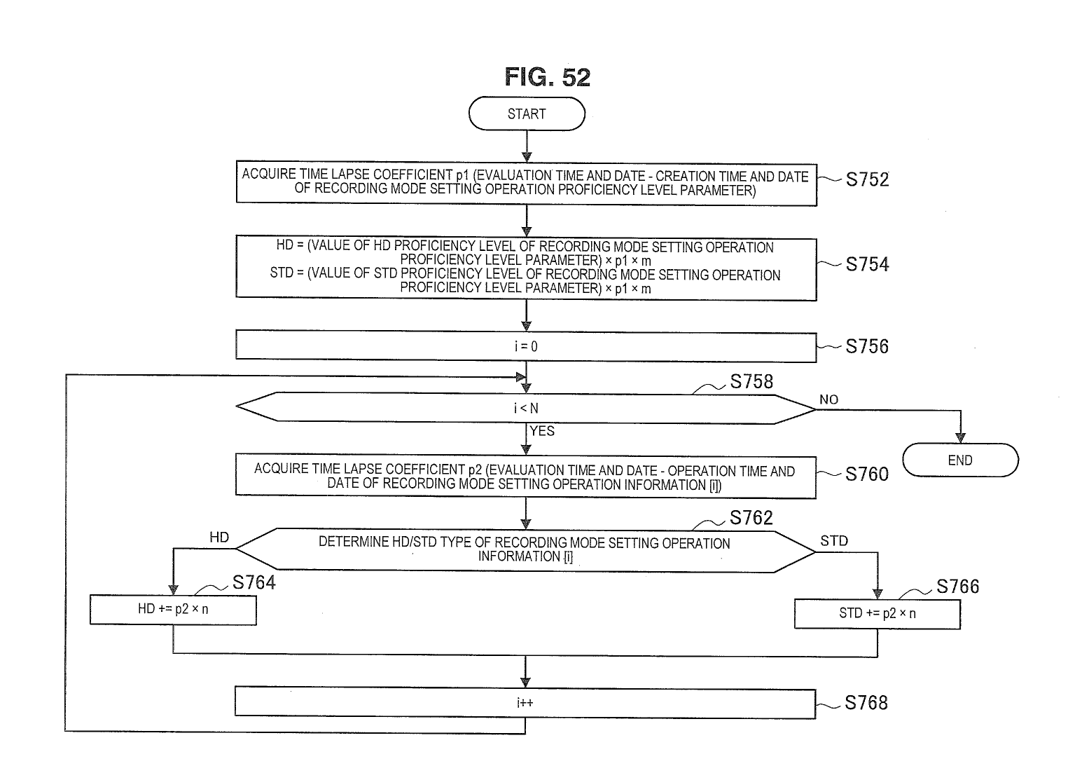

Here, specific evaluation processing of the recording mode setting operation proficiency level parameter 143 is described with reference to FIG. 52. FIG. 52 is a flowchart to describe one example of evaluation processing of the recording mode setting operation proficiency level parameter 143. The evaluation processing illustrated in FIG. 52 is performed when the user sets a recording mode, for example.

In the flowchart of FIG. 52, first, the UI display/operation performance evaluation learning unit 150 calculates time lapse coefficient p1 (step S752). Time lapse coefficient p1 becomes a value based on the elapsed time from the creation time and date of the previous recording mode setting operation proficiency level parameter to the current evaluation time.

Next, the UI display/operation performance evaluation learning unit 150 calculates evaluation value HD of the HD recording mode and evaluation value STD of the STD recording mode, which reflect weighting coefficient m and time lapse coefficient p1, like equations listed below (step S754).

HD=(value of HD proficiency level of recording mode setting operation proficiency level parameter)×p1×m

STD=(value of STD proficiency level of recording mode setting operation proficiency level parameter)×p1×m

Next, the UI display/operation performance evaluation learning unit 150 sets “i” (where “i” is an integer equal to or greater than 0) to 0 (step S756). Next, the UI display/operation performance evaluation learning unit 150 determines whether “i” is a less than recording mode setting operation information number N recorded in the recording mode setting operation history information (step S758).

In a case where “i” is less than N in step S758 (Yes), the UI display/operation performance evaluation learning unit 150 calculates time lapse coefficient p2 (step S760). Time lapse coefficient p2 becomes a value based on the elapsed time from the operation time and date of recording mode setting operation information [i] to the current evaluation time.

Next, the UI display/operation performance evaluation learning unit 150 determines the recording mode type of recording mode setting operation information [i] (step S762). Subsequently, in a case where it is determined that the recording mode is HD in step S762, the UI display/operation performance evaluation learning unit 150 calculates evaluation value HD reflecting time lapse coefficient p2 again, like an equation listed below (step S764).

HD+=p2×n

In a case where it is determined that the recording mode is STD in step S762, the UI display/operation performance evaluation learning unit 150 calculates evaluation value STD reflecting time lapse coefficient p2 again, like an equation listed below (step S766).

STD+=p2×n

Subsequently, when evaluation value HD or STD is calculated, the UI display/operation performance evaluation learning unit 150 increments “i” only by 1 (step S768) and repeats the processing in step S758 and subsequent steps.

On the other hand, in a case where “i” is not less than N in step S758 (No), the present processing ends. As a result of this, the recording mode setting operation proficiency level parameter 143 is calculated in which the values of the proficiency levels of the HD recording mode and the STD recording mode are recreated.

(4-4. Setting of Default List View According to Preference Level of List View)

The UI display unit 110 of the information processing apparatus 100 can display a list of content. Examples of the content include a taken image, the UI display unit 110 displays a list of taken images as thumbnail images.

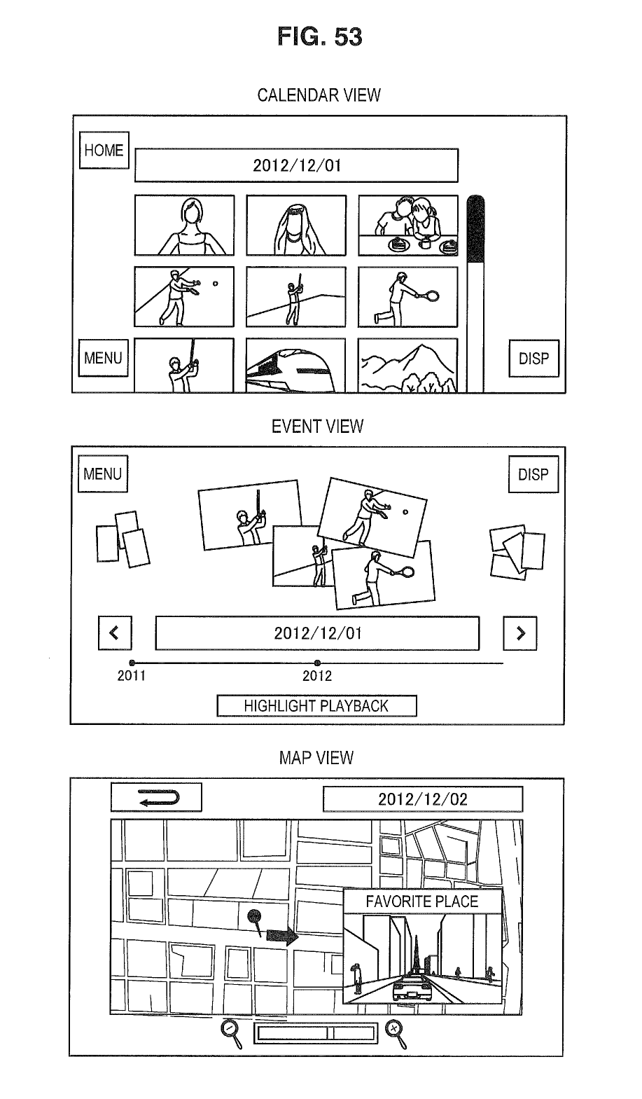

FIG. 53 is a diagram illustrating one example of multiple content list views that can be displayed by the UI display unit 110. As illustrated in FIG. 53, the UI display unit 110 can select and display a calendar view, an event view and a map view as a content list view. Images are displayed in association with respective times and dates in the calendar view, images are displayed in association with respective events in the event view, and images are displayed in association with a map in the map view.

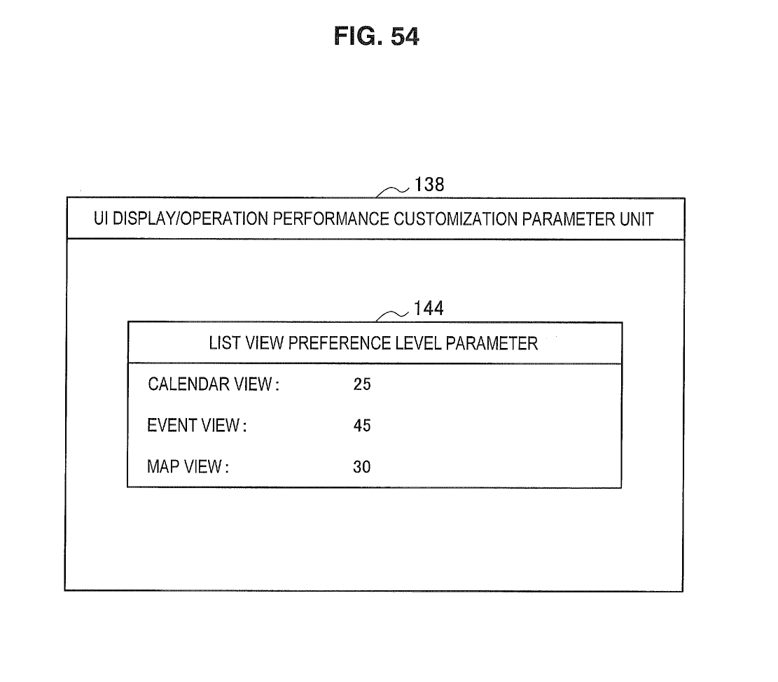

By the way, in the present embodiment, a default list view displayed on the UI display unit 110 is set according to the preference level of the multiple content list views. At the time of the list view default setting, the list view preference level parameter 144 illustrated in FIG. 54 is used.

FIG. 54 is a diagram to describe the list view preference level parameter 144. As illustrated in FIG. 54, the list view preference level parameter 144 includes information about numeric conversion of the preference levels of the calendar view, the event view and the map view. The preference level shows which view of the three views is favorite, and a view with a larger value is user's favorite.

The UI display/operation performance control unit 120 illustrated in FIG. 1 decides a default content list view at the time of displaying content, with reference to the list view preference level parameter 144. To be more specific, the UI display/operation performance control unit 120 decides a view with the largest numerical value of the preference level among the calendar view, the event view and the map views, as a default content list view.

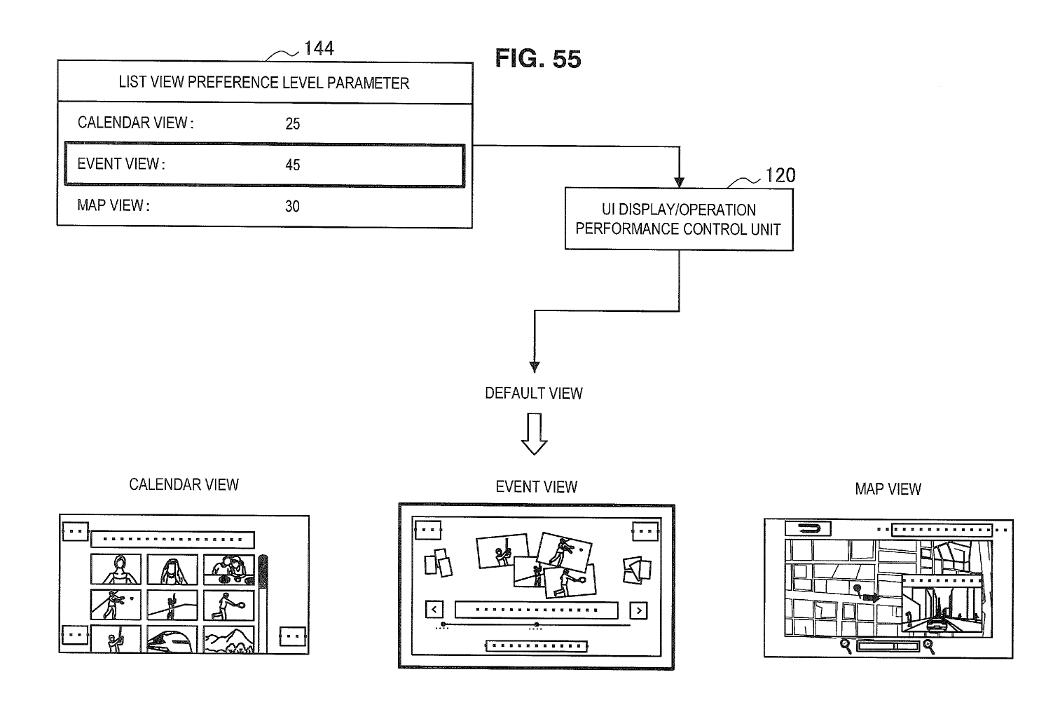

FIG. 55 is a diagram to describe a decision method of a default content list view. In FIG. 55, the UI display/operation performance control unit 120 decides the event view with the largest numerical value of the preference level among the calendar view, the event view and the event view, as a default content list view, and displays it on the UI display unit 110.

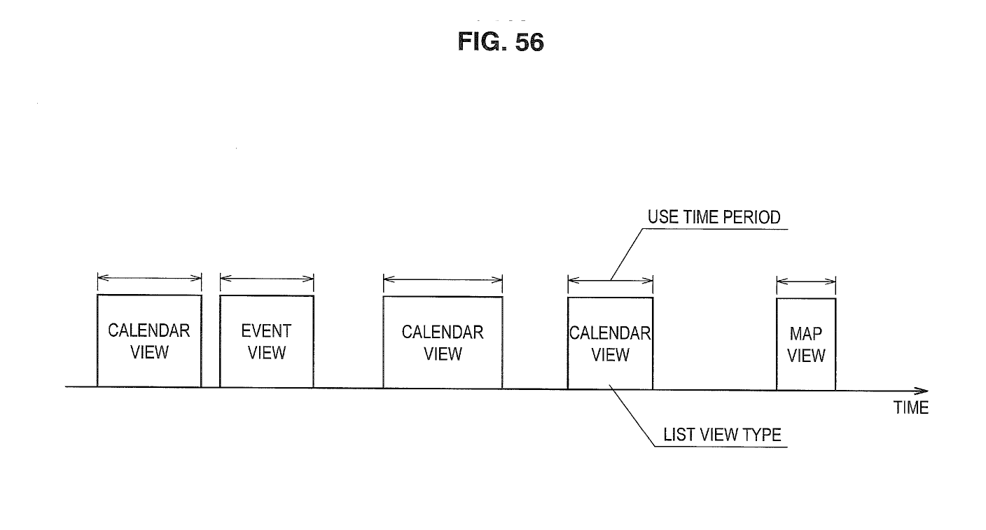

The operation history information unit 136 illustrated in FIG. 1 stores list view history information using a content list view, as an operation history. Here, as illustrated in FIG. 56, it is assumed that a plurality of list views is used in the previous predetermined time period.

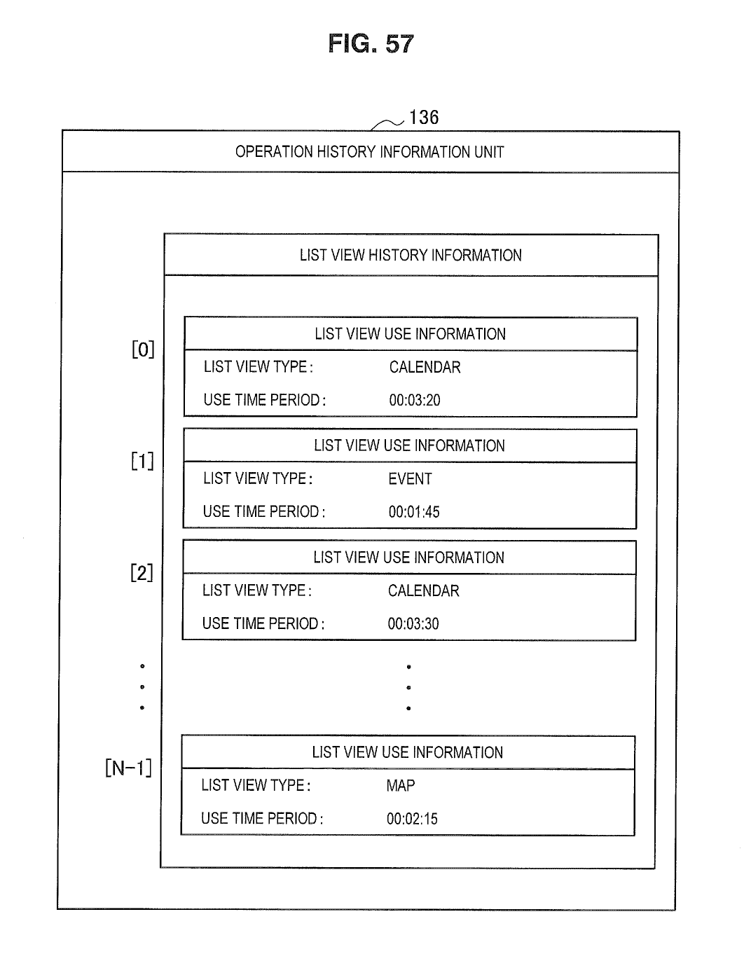

FIG. 56 is a diagram illustrating one example of the use history of the calendar view, the event view and the map view. In FIG. 56, the content list views are used in order of the calendar view, the event view, the calendar view, the calendar view to the map view. In such a case, as illustrated in FIG. 57, the operation history information unit 136 extracts and stores previous N items of list view use information.

FIG. 57 is a diagram to describe list view history information. The list view history information illustrated in FIG. 57 includes the previous N items of list view use information corresponding to FIG. 56. The previous N items of list view use information each include information about the list view type and the use time period.

The UI display/operation performance evaluation learning unit 150 illustrated in FIG. 1 has a function to evaluate the list view preference level parameter 144 of the customization parameter unit 138 on the basis of list view history information and reconfigure the list view preference level parameter 144. Therefore, the updated list view preference level parameter 144 is stored in the customization parameter unit 138.

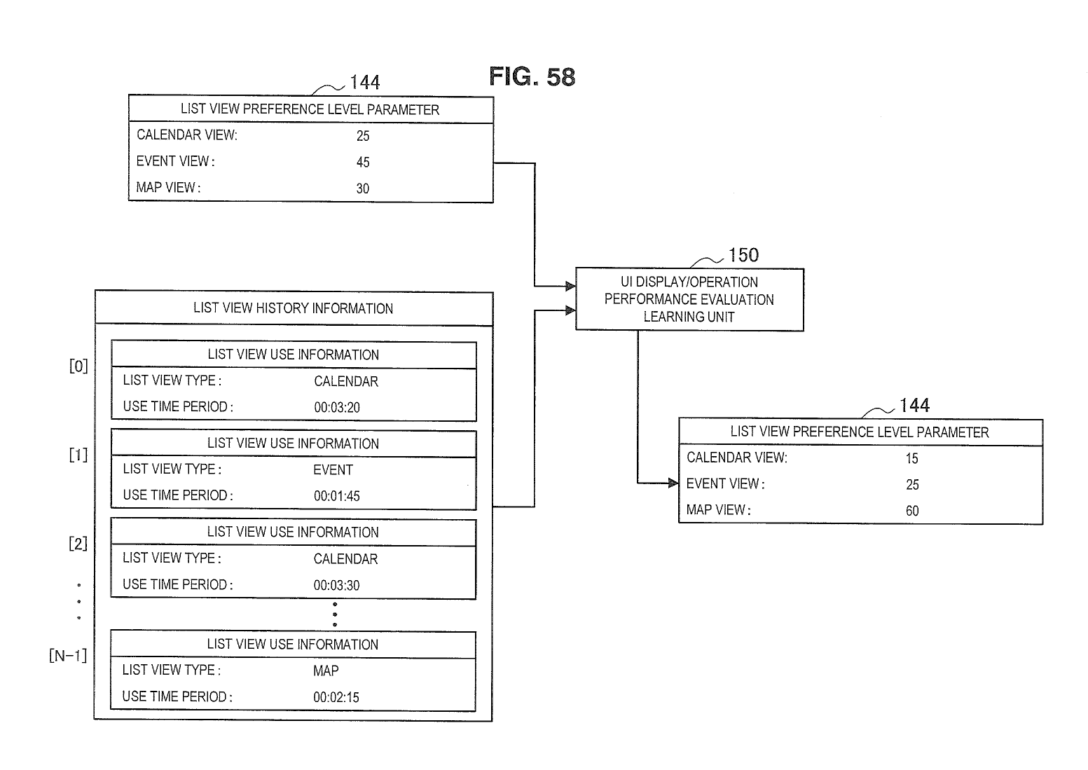

FIG. 58 is a diagram to describe the flow of the evaluation processing of the list view preference level parameter 144. As illustrated in FIG. 58, the UI display/operation performance evaluation learning unit 150 performs combination by evaluating the list view preference level parameter 144 evaluated last time and previous N items of list view use information, and changes the values of the preference levels of the calendar view, the event view and the map view. That is, the list view preference level parameter 144 to which the previous list view use history is reflected is generated.

At the time of evaluation, the UI display/operation performance evaluation learning unit 150 weights the list view preference level parameter 144 evaluated last time and the previous N items of list view use information.

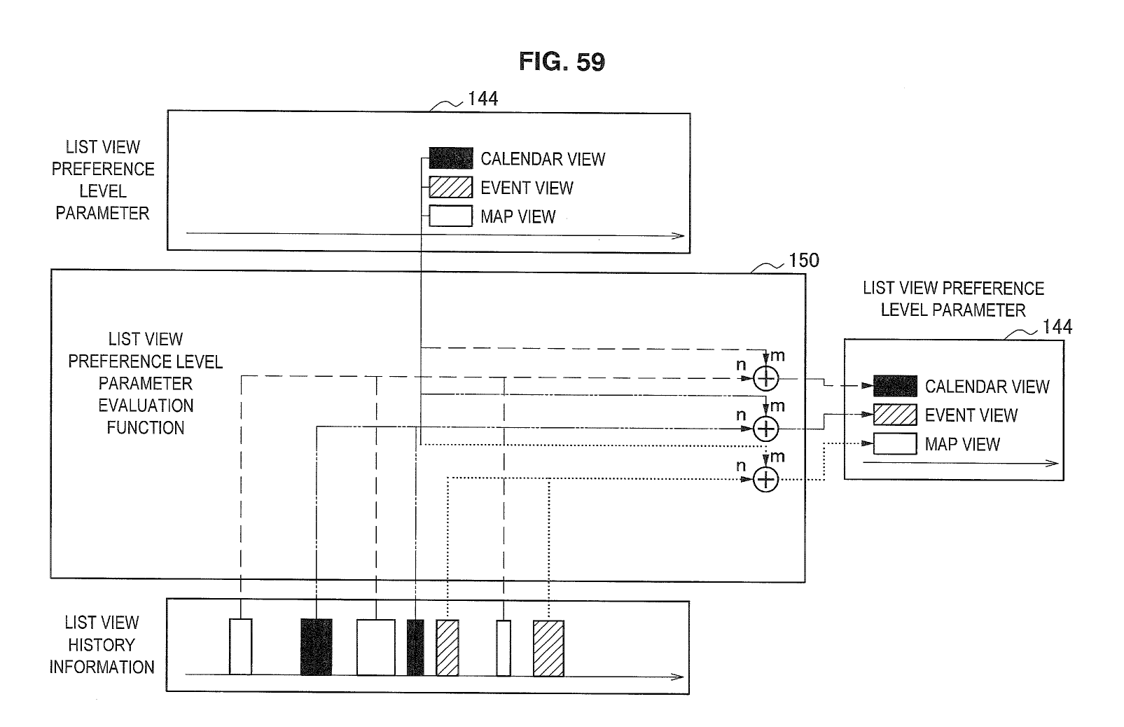

FIG. 59 is a diagram to describe weighting coefficients at the time of evaluating the list view preference level parameter 144. At the time of combining the list view preference level parameter 144 evaluated last time and the previous N items of list view use information, the UI display/operation performance evaluation learning unit 150 multiplies the numerical value of the preference level of the list view preference level parameter 144 evaluated last time by a weighting coefficient m. Moreover, the UI display/operation performance evaluation learning unit 150 multiplies the use time period of the previous N items of list view use information by a weighting coefficient n.

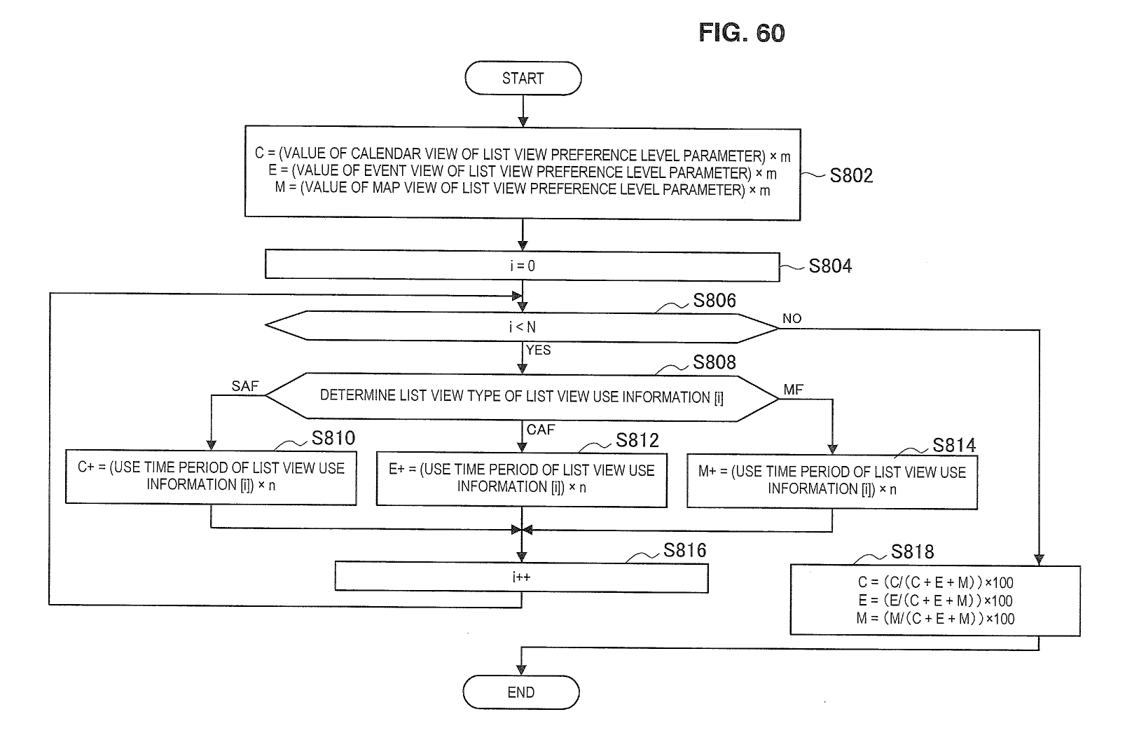

Here, specific evaluation processing of the list view preference level parameter 144 is described with reference to FIG. 60. FIG. 60 is a flowchart to describe the evaluation processing of the list view preference level parameter. For example, the evaluation processing illustrated in FIG. 60 is performed at the display transition time of list views.

In flowchart of FIG. 60, first, the UI display/operation performance evaluation learning unit 150 weights the numerical values of the calendar view, event view and map view of the list view preference parameter evaluated last time, like equations listed below, and calculates evaluation values C, E and M (step S802).

C=(numerical value of calendar view of list view preference level parameter)×m

E=(numerical value of event view of list view preference level parameter)×m

M=(numerical value of map view of list view preference level parameter)×m

Here, “m” of the above-mentioned equations is a weight coefficient with respect to the previous list view preference level parameter and is set in advance.

Next, the UI display/operation performance evaluation learning unit 150 sets “i” (where “i” is an integer equal to or greater than 0) to 0 (step S804). Next, the UI display/operation performance evaluation learning unit 150 determines whether “i” is less than list view use information number N recorded in the list view history information (step S806).

In a case where “i” is less than N in step S806 (Yes), the UI display/operation performance evaluation learning unit 150 determines the list view type of list view use information [i] in the list view history information (step S808). Subsequently, in a case where the list view type is the calendar view in step S808, the UI display/operation performance evaluation learning unit 150 performs weighting on the use time period of list view use information [i] like an equation listed below, and calculates evaluation value C of the calendar view again (step S810).

C+=(use time period of list view use information[i])×n

Here, “n” of the above-mentioned equation is a weight coefficient with respect to list view use information [i] and is set in advance.

In a case where the list view type is the event view in step S808, the UI display/operation performance evaluation learning unit 150 calculates evaluation value E of the event view again, like an equation listed below (step S810).

E+=(use time period of list view use information[i])×n

In a case where the list view type is the map view in step S808, the UI display/operation performance evaluation learning unit 150 calculates evaluation value M of the map view again, like an equation listed below (step S810).

M+=(use time period of list view use information[i])×n

Subsequently, when any of evaluation values C, E and M is calculated, the UI display/operation performance evaluation learning unit 150 increments “i” only by 1 (step S816) and repeats the processing in step S806 and subsequent steps. On the other hand, in a case where “i” is not less than N in step S806 (No), normalization is performed (step S818) and the present processing ends. As a result of this, the list view preference parameter is calculated in which the numerical values of the preference levels of the calendar view, the event view and the map view are reconfigured.

Here, in the above description, although weighting coefficients m and n are multiplied at the time of calculating evaluation values C, E and M, it is not limited to this and it may be possible to multiply the weighting coefficients and the time lapse coefficients as illustrated in FIG. 28, for example.

### 5. CONCLUSION

As described above, the information processing apparatus 100 of the present embodiment combines time lapse information and operation history information and changes the customization parameter of the customization parameter unit 138. As a result of this, even if the user does not change the customization parameter, it is automatically changed to an optimal customization parameter according to the operation state of the information processing apparatus 100.

Especially, since time lapse information is considered in the present embodiment, in a case where the operation is not performed for a long time after it gets used to the operation, the setting value of the customization parameter returns to the origin and therefore customization suitable for the proficiency level at the current time is possible.

Moreover, even in a case where a plurality of users operates the information processing apparatus 100, since the customization parameter is changed for each user like the present embodiment, it is possible to change it to an optimal customization parameter suitable for the operation state of the user who uses the information processing apparatus 100 at the current time.

Although the preferred embodiments of the present disclosure have been described in detail with reference to the accompanying drawings, the technical scope of the present disclosure is not limited to such an example. It should be understood by those skilled in the art that various modifications, combinations, sub-combinations and alterations may occur depending on design requirements and other factors insofar as they are within the scope of the appended claims or the equivalents thereof.

Moreover, the steps illustrated in the flowcharts of the above-mentioned embodiments include not only the processing performed in series along the described order but also the processing performed in a parallel or individual manner even if the processing is not performed in series. Moreover, it is needless to say that it is possible to adequately change the order of steps processed in series according to circumstances.

The processing by the information processing apparatus described in the specification may be realized using software, hardware or a combination of software and hardware. Programs forming the software are stored in advance in a storage medium installed inside or outside each apparatus, for example. Subsequently, for example, each program is read in a RAM (Random Access Memory) at the time of execution and executed by a processor such as CPU.

Additionally, the present technology may also be configured as below.

(1) An information processing apparatus including:

a setting change unit configured to change a setting of an apparatus based on operation history information related to an operation history of the apparatus; and

a time lapse acquisition unit configured to acquire time lapse information related to a time lapse,

wherein the setting change unit combines the time lapse information and the operation history information, and changes the setting of the apparatus.

(2) The information processing apparatus according to (1), wherein the setting of the apparatus relates to a setting of a user interface of the apparatus.
(3) The information processing apparatus according to (2), wherein the setting of the user interface is a setting of a list view to display a list of content in a display unit.
(4) The information processing apparatus according to (2), wherein the setting of the user interface is a setting related to imaging by an imaging unit.
(5) The information processing apparatus according to (1), wherein the setting of the apparatus relates to an imaging parameter at a time of imaging by an imaging unit.
(6) The information processing apparatus according to any one of (1) to (5), wherein the setting change unit executes one of a first mode and a second mode, where the first mode combines the time lapse information and the operation history information and changes the setting of the apparatus, and the second mode changes the setting of the apparatus based on the operation history information.
(7) The information processing apparatus according to any one of (1) to (6), wherein the setting change unit estimates a proficiency level of an operation based on the operation history information and changes the setting of the apparatus.
(8) The information processing apparatus according to any one of (1) to (7),

wherein the setting change unit changes a setting value of the apparatus based on the operation history information, and

wherein, in a case where the time lapse is long, the setting change unit returns the setting value to an original value.

(9) The information processing apparatus according to any one of (1) to (8), further including:

a storage unit configured to store the operation history information for each of multiple users who can operate the apparatus.

(10) The information processing apparatus according to any one of (1) to (9), further including:

a storage unit configured to record a variable setting parameter of the apparatus for each of multiple users who can operate the apparatus.

(11) The information processing apparatus according to any one of (1) to (10), further including:

a registration unit configured to register a user who operates the apparatus.

(12) An information processing method including:

changing a setting of an apparatus based on operation history information related to an operation history of the apparatus; and

acquiring time lapse information related to a time lapse,

wherein changing the setting of the apparatus is to combine the time lapse information and the operation history information and change the setting of the apparatus.

(13) A program that causes a computer to execute:

changing a setting of an apparatus based on operation history information related to an operation history of the apparatus; and

acquiring time lapse information related to a time lapse,

wherein changing the setting of the apparatus is to combine the time lapse information and the operation history information and change the setting of the apparatus.

What is claimed is:

1. An information processing apparatus comprising:
a setting change unit configured to change a setting of an apparatus based on operation history information related to an operation history of the apparatus; and
a time lapse acquisition unit configured to acquire time lapse information related to a time lapse,
wherein the setting change unit combines the time lapse information and the operation history information, and changes the setting of the apparatus.

2. The information processing apparatus according to claim 1, wherein the setting of the apparatus relates to a setting of a user interface of the apparatus.

3. The information processing apparatus according to claim 2, wherein the setting of the user interface is a setting of a list view to display a list of content in a display unit.

4. The information processing apparatus according to claim 2, wherein the setting of the user interface is a setting related to imaging by an imaging unit.

5. The information processing apparatus according to claim 1, wherein the setting of the apparatus relates to an imaging parameter at a time of imaging by an imaging unit.

6. The information processing apparatus according to claim 1, wherein the setting change unit executes one of a first mode and a second mode, where the first mode combines the time lapse information and the operation history information and changes the setting of the apparatus, and the second mode changes the setting of the apparatus based on the operation history information.

7. The information processing apparatus according to claim 1, wherein the setting change unit estimates a proficiency level of an operation based on the operation history information and changes the setting of the apparatus.

8. The information processing apparatus according to claim 1,
wherein the setting change unit changes a setting value of the apparatus based on the operation history information, and
wherein, in a case where the time lapse is long, the setting change unit returns the setting value to an original value.

9. The information processing apparatus according to claim 1, further comprising:
a storage unit configured to store the operation history information for each of multiple users who can operate the apparatus.

10. The information processing apparatus according to claim 1, further comprising:
a storage unit configured to record a variable setting parameter of the apparatus for each of multiple users who can operate the apparatus.

11. The information processing apparatus according to claim 1, further comprising:
a registration unit configured to register a user who operates the apparatus.

12. An information processing method comprising:
changing a setting of an apparatus based on operation history information related to an operation history of the apparatus; and
acquiring time lapse information related to a time lapse,
wherein changing the setting of the apparatus is to combine the time lapse information and the operation history information and change the setting of the apparatus.

13. A program that causes a computer to execute:
changing a setting of an apparatus based on operation history information related to an operation history of the apparatus; and
acquiring time lapse information related to a time lapse,
wherein changing the setting of the apparatus is to combine the time lapse information and the operation history information and change the setting of the apparatus.
